(19) United States
(12) Patent Application Publication
(10) Pub. No.: US 2010/0199222 A1
(43) Pub. Date: Aug. 5, 2010

(54) DYNAMIC FAMILY TREE REPRESENTATION

(75) Inventors: Michael E. P. Kranik, Saint Petersburg, FL (US); Jill K. Bensen, Saint Petersburg, FL (US); Jacek A. Lech, Rzeszow (PL); Andrzej Szkola, Palm Harbor, FL (US); Laura Rodrigues de Miranda,Laura, Holiday, FL (US); Leszek P. Rumak, Dunedin, FL (US)

Correspondence Address: WOLF GREENFIELD & SACKS, P.C., 600 ATLANTIC AVENUE, BOSTON, MA, 02210-2206, US

(73) Assignee: Soft Computer Consultants, Inc.

(21) Appl. No.: 12/363,083

(22) Filed: Jan. 30, 2009

(51) Int. Cl. G06F 3/048; G06F 17/30

(52) U.S. Cl. 715/853; 707/E17.005; 707/E17.05; 707/E17.048

(57) ABSTRACT

In one aspect, a method for interacting with a representation of a family tree is provided. The method comprises receiving family tree information from a user with respect to the family tree, displaying a representation of the family tree based, at least in part, on the received family tree information, receiving update information from the user indicating at least one modification to the family tree and/or the family tree representation, the update information received via the user interacting directly with the graphical representation of the family tree, performing the at least one modification to the family tree and/or family tree representation, and displaying a representation of the family tree with the at least one modification.

### FIELD OF THE INVENTION

The present invention relates to family studies, and more particularly, to methods and apparatus for representing a family tree.

### BACKGROUND

The field of genetics information is rapidly unfolding and methods of managing the information including providing useful software technology to visualize, analyze and archive information are becoming increasingly important. Various software products to manage genetics information are currently in use in medical laboratories and offer a range of genetics tools to automate workflow in the medical genetics laboratories. Genetics management systems may utilize up-to-date technologies to make the software Web-accessible and to offer a selection of cytogenetics, molecular, flow cytometry, and immunogenetics systems that may be configured to allow for predefined or unique, user-defined protocols. Genetic information systems (GIS) may be provided to address issues in various genetic testing processes, such as experimental design, direction of workflows through automated equipment, management of samples and tracking of inventory items.

Genetics management systems may enable users to track ordered genetic tests at different stages such as DNA/RNA extraction, amplification, detection and interpretation. Reporting functionality may provide users with accurate, intuitive data analysis and result reporting capability that facilitates comprehension of results obtained from complex genetics tests. Features such as enterprise-wide reporting functionality enables users to track the status of tests and tasks, and daily manager worklist queues assist in keeping technologists informed of changes in the experimental lifecycle.

Genetics management systems may also allow for the management of information derived from multiple modules, and provide researchers and clinicians (for example, those deriving information from anatomical pathology laboratories) with a central access point to enter interpretation of tests results obtained from multiple software applications, and to enter and edit conclusions from large volumes of samples, experimental workflows, and other information management concerns through the informatics pipeline.

Genetics management systems may also allow processing of cases using workflow scenarios as determined by laboratory standard operating procedures (SOPs), such as culture setup through culture harvesting, slide processing, data analyses and results reporting. Information management functionality may facilitate action items such as sample processing and quality control queries through a browser-based, Web-enabled graphical user interface (GUI). Management software may offer real-time reporting functionality with daily accessioning, order, and results logs so users can stay up to date on each phase of an experiment. Regulatory requirements may be addressed by making compliance via, for example, capture of enterprise-wide audit trails from samples for regulatory compliance, making it easier for organizations to maintain regulatory compliance without taking on unnecessary costs or suffering setbacks from failing to meet regulatory compliance requirements.

### SUMMARY

To address at least some drawbacks associated with conventional static representations of family trees, some aspects of the invention are directed to a software program that can display and maintain a dynamic and/or interactive family tree representation to facilitate understanding, visualizing and/or analyzing family relationships. According to some embodiments, a family tree representation may be obtained either by using manual input, by querying and retrieving information from a patient database or a combination of both. Patient information and/or family relationship information that is manually input may be saved in a patient database to facilitate subsequent family studies, or to more fully automate the process of building a family tree.

According to some embodiments, a graphical family tree representation is presented to a user, wherein the family tree may be dynamically updated via the graphical family tree representation. For example, the graphical family tree representation may include interface functionality that allows a user to perform any one or combination of selecting family members, updating and/or modifying the family tree, or editing one or more display options with respect to how the family tree is represented and displayed.

Some embodiments include a method for interacting with a representation of a family tree, the method comprising receiving family tree information from a user with respect to the family tree, displaying a representation of the family tree based, at least in part, on the received family tree information, receiving update information from the user indicating at least one modification to the family tree and/or the family tree representation, the update information received via the user interacting directly with the graphical representation of the family tree, performing the at least one modification to the family tree and/or family tree representation, and displaying a representation of the family tree with the at least one modification.

Some embodiments include a computer readable medium encoded with a program for execution on at least one processor, the program, when executed on the at least one processor, performing a method for interacting with a representation of a family tree, the method comprising receiving family tree information from a user with respect to the family tree, displaying a representation of the family tree based, at least in part, on the received family tree information, receiving update information from the user indicating at least one modification to the family tree and/or the family tree representation, the update information received via the user interacting directly with the graphical representation of the family tree, performing the at least one modification to the family tree and/or family tree representation, and displaying a representation of the family tree with the at least one modification.

Some embodiments include a system for interacting with a representation of a family tree. The system comprising a database for storing at least patient information, and a software module coupled to the database and capable of accessing patient information from the database. The software module is configured to provide at least one first interface for display to receive family tree information from a user related to the family tree, display a representation of the family tree based, at least in part, on the received family tree information, provide at least one second interface for display accessible directly on the representation of the family tree to receive update information from the user indicating at least one modification to the family tree, modify the family tree according to the update information, and display a representation of the family tree with the at least one modification.

### BRIEF DESCRIPTION OF THE DRAWINGS

FIGS. 1A and 1B illustrate software systems for accessing, manipulating, analyzing and/or presenting information stored in a patient database, in accordance with some embodiments of the present invention;

FIG. 2 is a flowchart illustrating a method for obtaining, displaying and interacting with a family tree representation, in accordance with some embodiments of the present invention;

FIG. 3 illustrates an exemplary graphical family tree representation provided by a family tree module, in accordance with some embodiments of the present invention;

FIGS. 4A and 4B illustrate search options in a family browser window that allows a user to find an existing family tree either by searching by family or by individual patient, in accordance with some embodiments of the present invention;

FIG. 4C illustrates an example of a screen presented in response to a user pressing the “Find” button in FIG. 4A with specified criteria, in accordance with some embodiments of the present invention;

FIGS. 5A-5E illustrates interface functionality for obtaining an existing family tree, in accordance with some embodiments of the present invention;

FIGS. 6A-6F illustrate interface functionality for entering family member information via the Patient Maintenance window for some exemplary members of the specified family, in accordance with some embodiments of the present invention;

FIGS. 7A-7D illustrate interface functionality for adding a target member to an existing is family, in accordance with some embodiments of the present invention;

FIG. 8 illustrates a graphical representation of the family tree established using any of the above described interface functionality to either build a family tree relationship or obtain/retrieve an existing family tree for display, in accordance with some embodiments of the present invention;

FIG. 9 illustrates the family tree representation after the target family member has been selected and the user has indicated that the user would like to view further options for the selected family member, in accordance with some embodiments of the present invention;

FIG. 10A illustrates an add relation operation performed by a user-initiated action directly applied to the family tree representation, in accordance with some embodiments of the present invention;

FIG. 10B illustrates the family tree after the add relation operation illustrated in FIG. 10A has been performed, in accordance with some embodiments of the present invention;

FIG. 11A illustrates an interface presented to a user to allow the user to search for a family member in the database to automatically populate at least some information associated with the family member, in accordance with some embodiments of the present invention;

FIG. 11B and FIG. 11C illustrate the results after the user selected a family member from the results of the demographic query illustrated in FIG. 11A, in accordance with some embodiments of the present invention;

FIG. 12A-12H illustrate interface functionality for creating a new family tree and defining relationships via the “Connect to” option from the options menu, allowing the user to connect and establish family member relationships via a graphical representation of the family tree, in accordance with some embodiments of the present invention;

FIG. 13A illustrates a user having selected the “Delete Individual” option from the options menu to delete a selected family member from the family tree, in accordance with some embodiments of the present invention;

FIG. 13B illustrates a representation of the family tree after the selected family member has been deleted, in accordance with some embodiments of the present invention;

FIGS. 14A-14C illustrate examples of changing and/or setting various properties of the family members in the family tree via the representation of the family tree, in accordance with some embodiments of the present invention;

FIG. 15A illustrates a user selecting the “Attributes” option in the options menu for the target family member who has been selected, in accordance with some embodiments of the present invention;

FIG. 15B illustrates a window presented by the family tree module as a result of receiving the indication from the user via the “Attributes” option, in accordance with some embodiments of the present invention;

FIG. 16A illustrates a user having selected the “Properties” option under the options menu, in accordance with some embodiments of the present invention;

FIG. 16B illustrates a Person Property window displayed in response to the user selecting the “Properties” option illustrated in FIG. 16A, in accordance with some embodiments of the present invention;

FIG. 16C illustrates that a user may access Attribute List window via the Personal Property window and edits or modifications to the attributes, including adding a new attribute may be performed in this manner, in accordance with some embodiments of the present invention;

FIG. 17 illustrates the result of a user clicking on the “Patterns” button to view the extended attributes for the selected family member, in accordance with some embodiments of the present invention;

FIG. 18A illustrates a Person Attribute window that allows a user to a add new attribute that the user would like to add to the attribute list, in accordance with some embodiments of the present invention;

FIG. 18B illustrates the extended attribute list after a new attribute has been added, in accordance with some embodiments of the present invention;

FIGS. 18C and 18D illustrate interface functionality to allow the user to define where and in what manner a new attribute is displayed, in accordance with some embodiments of the present invention; and

FIG. 18E illustrates a personal attribute window that allows a user to assign a value to a new attribute, in accordance with some embodiments of the present invention.

### DETAILED DESCRIPTION

As discussed above, genetics information management tools have become increasingly important to support the large volume of information and genetics tests and studies that are being conducted in genetics laboratories and research hospitals. It has become increasingly important to implement functionality, either integrated with genetics information management tools or as standalone applications, to assist in organizing, visualizing, analyzing and/or archiving the wealth of information that is being generated in medical laboratories and hospitals.

It may be useful to have the ability to identify family relationships in family studies and to display a graphical representation of a family tree as a way to visualize family relationships and information, thus facilitating organization of information and further analysis in a family study. However, conventional family tree representations typically have a number of drawbacks. In particular, conventional family tree representations may be static and may not offer functionality that permits a user to interact with the graphical representation itself rendering the representation inflexible and less effective in facilitating thorough understanding, visualization and/or analysis of complex family relationships.

In addition, such static representations may not be well integrated with available patient databases or other archival information from which family relationships may be derived, As a result, building a conventional family tree representation may require relatively significant manual input. Moreover, family tree representation may be limited to displaying only the specific information that was manually input to create the corresponding family tree. Such static and inflexible solutions may be inconvenient, time consuming, and ultimately unhelpful in visualizing, understanding and analyzing family relationships, particularly with respect to a family study where genetic and/or hereditary information is being analyzed, for example, in the analysis of disease, hereditary traits, etc.

Applicant has appreciated that a software program that can display and maintain a dynamic and/or interactive family tree representation may be a valuable tool in understanding, visualizing and/or analyzing family relationships. According to some embodiments, a family tree representation may be obtained either by using manual input, by querying and retrieving information from a patient database or a combination of both. Patient information and/or family relationship information that is manually input may be saved in the patient database to facilitate subsequent family studies, or to more fully automate the process of building a family tree.

According to some embodiments, a graphical family tree representation is presented to a user, wherein the family tree may be dynamically updated via the graphical family tree representation. For example, the graphical family tree representation may include interface functionality that allows a user to perform any one or combination of various actions such as selecting family members, updating and/or modifying the family tree, or editing one or more display options with respect to how the family tree is represented and displayed. For example, interface functionality may be provided that allows a user to perform any one or combination of the following: add a new family member; define family relationships; search for family members using demographic information; connect to a family member; add/modify status information; customize display information; delete an individual from the family tree; define and/or add new attributes; modify attributes, etc., by interacting directly with the graphical representation itself According to other embodiments, other interactions with the family tree representation may be performed, as the aspects of the invention are not limited in this respect.

Following are more detailed descriptions of various concepts related to, and embodiments of methods and apparatus according to the present invention. It should be appreciated that various aspects of the invention described herein may be implemented in any of numerous ways. Examples of specific implementations are provided herein for illustrative purposes only. In addition, the various aspects of the invention described in the embodiments below may be used alone or in any combination, and are not limited to the combinations explicitly described herein.

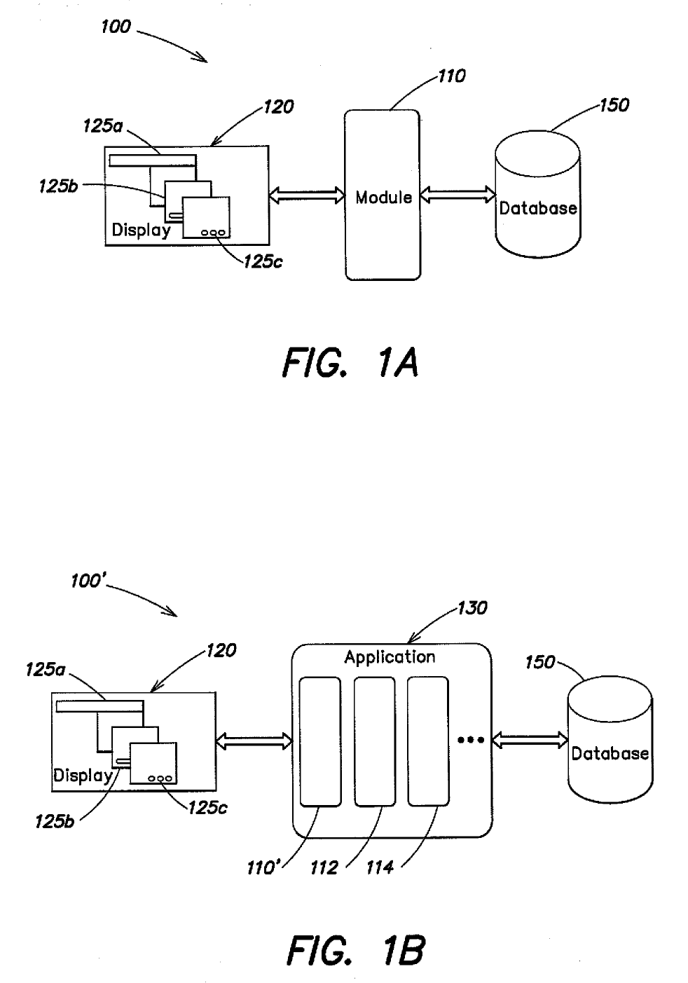

FIGS. 1A and 1B illustrate software systems for accessing, manipulating, analyzing and/or presenting information stored in a database of information, in accordance with some embodiments of the present invention. Software system 100 includes a database 150, a module 110 and a display 120. The database may be any database containing information that is relevant and accessible by module 110. For example, database 150 may include a laboratory information system (LIS) database containing information about patients, laboratory processes, information related to specimens, and/or any other information relevant to laboratory or hospital operations. Database 150 may, alternatively or in addition to, include a genetic information system (GIS) database containing patient information, information related to genetic lab operations including, but not limited to, cytogenetics, molecular, flow cytometry, and immunogenetics and/or any other relevant genetics information. In the context of family tree functionality, database 150 will typically include at least patient information for a patient for whom it is desired to build a family tree, and may therefore be referred to simply as a patient database even though the database may include information beyond mere patient information.

Module 110 of system 100 is connected to database 150 and may be adapted to both query and obtain information from the database as well as add and store additional information in the database. Module 110 may be a standalone application or may be an integrated component or plug-in of another software application (e.g., may be part of a set of tools as illustrated in FIG. 1B). Module 110 may include one or more software programs configured to operate as a functional interface between module 110 and display 120. Display 120 may be any type of display capable of displaying information provided by module 110. For example, display 120 may be a computer monitor, a television screen, a display on a mobile device such as a cellular phone, personal digital assistant (PDA), or any other type of display capable of presenting information to a user.

Module 10 may be configured to display any number of interface objects 125 on display 120 to allow a user to interact with the module and/or database. For example, module 110 may present windows (e.g., window 125b), icons, menus (e.g., menu 125a), buttons (e.g., button 125c), etc. that allow a user to convey actions and/or that display information from module 110 and/or database 150. Module 110 may provide any sort of interface functionality such as voice activation, touch screen operation, gesture-based interfaces and/or any type of WIMP interface components, as the aspects of the invention are not limited for use with any particular type of interface technology. For example, display 120 may be a display in the familiar context of a personal computer having a mouse and a keyboard as input devices, and the display as an output device. Accordingly, a user may interact with the information stored in the database via the functionality provided by module 110.

Module 110 specifically includes functionality that assists a user in creating, building or accessing a family tree, and functionality that provides a graphical family tree representation to be presented on display 120. According to some embodiments, module 110 provides functionality that allows a user to interact with the graphical family tree representation, as discussed in further detail below.

FIG. 1B illustrates a software system 100′ that may operate in a manner similar to software system 100. However, software system 100 0 includes an application 130 that includes a plurality of modules 110′, 112, 114, etc. In particular, application 130 may allow a user to interact with database 150 according to functionality provided by a collection of modules, which may include a module (e.g., module 110′) configured to provide family tree functionality according to at least some of the aspects of the invention.

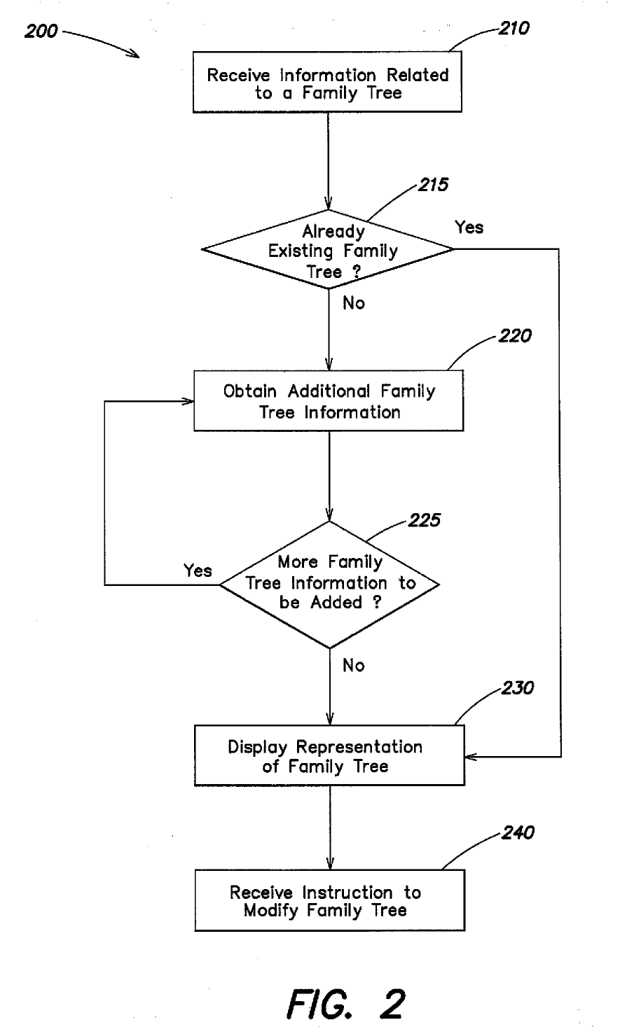

Application 130 may include, in addition to family tree functionality, modules that provide genetic functionality, laboratory operations, management of specimens and laboratory processes, etc. For example, application 130 may be similar to the Genetics Information Systems software developed and sold by SCC SoftComputer incorporating any one or combination of modules including, but not limited to, SoftMolecular®, SoftCytogenetics®, SoftFlowCytometry®, SoftHLA™, etc. Accordingly, modules 110/110′ may be a stand-alone software module or application, or may be included in a collection of modules, tools and/or software solutions, as the aspects of the invention are not limited in this respect, FIG. 2 is a flowchart illustrating a method for obtaining and displaying family tree information and interacting with a family tree representation, in accordance with some embodiments of the present invention. Method 200 may be performed on either of the software systems described in connection with and illustrated in FIGS. 1A and 1B. For example, method 200 may be performed by executing, via one or more processors, a set of instructions stored on a computer readable medium, such as a memory. That is, module 110/110′ may comprise instructions for performing method 200 and other methods described herein.

In act 210, information about a family tree of interest is received from a user. For example, module 110/110′ described in connection with FIGS. 1A and 1B, respectively, may provide interface functionality that allows the user to indicate that the user would like to create a new family tree or that allows the user to input information about a target family member whose pedigree (i.e., family free) the user would like to display. As discussed above, module 110/110′ includes family tree functionality and therefore will be referred to herein as a family tree module, even though it may include additional functionality.

Alternatively or in addition to, the family tree module may provide functionality to allow the user to search and select a target family member from a database (e.g., database 150) for use in creating a family tree for display. According to some embodiments, the family tree or a part of the family tree may already exist (e.g., the family tree may have already been created and built using the functionality of the family tree module and stored in memory, e.g., a patient database). Accordingly, the information from the user may relate to a query or search for the existing family tree, or may relate to identifying information about the family tree. The information from the user related to a family tree for display and interaction may be received via any interface mechanism provided by the family tree module, as the aspects of the invention are not limited in this respect.

In act 215, the family tree module may determine whether the user has indicated that the user would like to display an already existing family tree. For example, if the user searches for or browses and selects a desired family tree, the family tree module may simply display a representation of the family tree (see act 230). However, if the user indicates that the user would like to create and/or build a new family tree or add to an existing family tree, the family tree module may proceed to provide functionality to the user to allow the user to either provide further family tree information such as additional family members to be added to the family tree, or may provide interface functionality to allow the user to search for additional family members in the patient database.

In act 220, information regarding family relationships is received from the user. For example, the user may input or select from the patient database an initial family member from which to build the family tree. This target family member may be the proband or merely a family member from whom the user would like to expand the tree and define relationships, as discussed in further detail below. The user may also add a family relationship to the family tree being created or built based on the person's relationship with the initial or target family member. As with establishing the target family member, the family relationship may either be received by the user via interface functionality or obtained by querying the patient database. Alternatively, a family tree module may present interface functionality that allows a user to access and display a previously established family relationship. For example, the family tree module may present to the user one or more browser or search windows that allow the user to browse to or search for an already existing established family relationship and/or a family member whose information already exists in the patient database.

In act 225, it is determined whether another family relationship should be added to the pedigree. If another family member should be added to the family tree, act 220 may be repeated until no further family relationships are desired. When all the family relationships are added, or when an existing family tree has been obtained, a graphical representation of the family tree may be displayed to the user (act 230). For example, the family tree module may collect the target family member information and family relationships and present the family tree to the user graphically. Alternatively, if the user chooses to display an already existing family relationship or family tree, the family tree module may access the indicated family relationship or family tree (e.g., determined via browse or search functionality) and display a graphical representation of the family tree.

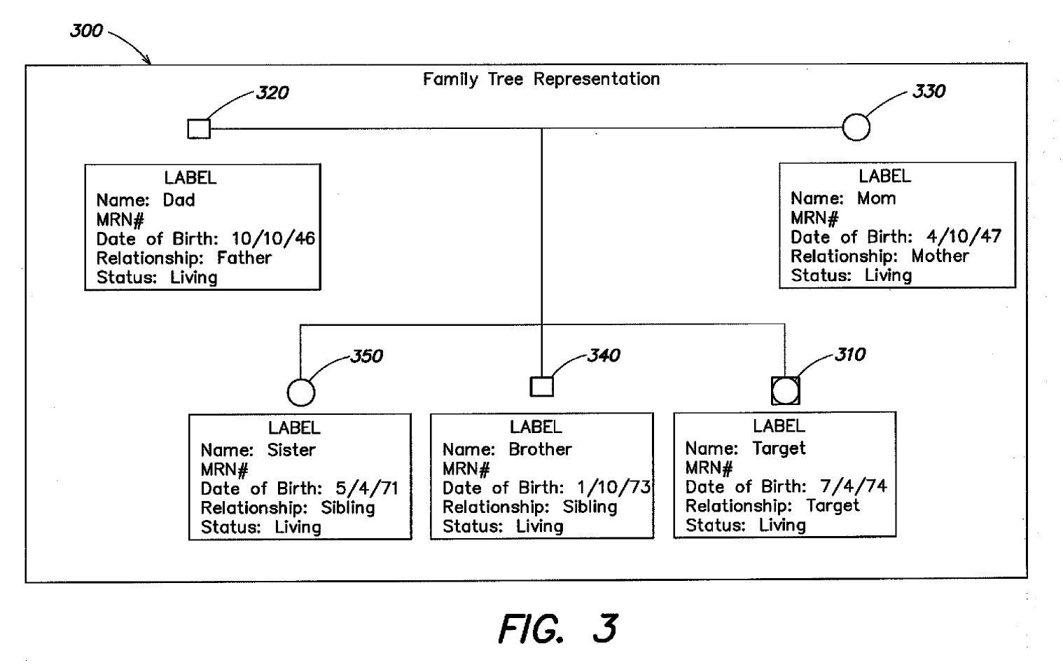

FIG. 3 illustrates an exemplary graphical family tree representation provided by a family tree module in accordance with some embodiments of the present invention. The term graphical representation refers herein to a representation that uses nodes and edges to depict dependencies between the nodes. In the context of a graphical representation of a family tree, the nodes represent family members and the edges represent lineage or relationship between the family members. In the family tree representation 300 in FIG. 3, each family member is represented by a graphical icon, for example, male family members may be denoted by squares and female family members may be denoted by circles. However, family members may be represented using any type of graphical icon and gender may be indicated by any means, or may not be distinguished graphically at all, as the aspects of the invention are not limited in this respect. The edges are depicted as lines indicating the relationship between family members and are generally displayed in a top down hierarchy from the oldest ancestor down through subsequent generations. Family members of the same generation may be represented at the same level of the hierarchy. The graphical representation 300 uses standard denotation and incorporates traditional and familiar structures for displaying a family tree to facilitate standardization. However, a family tree may be graphically represented in other ways, as the aspects of the invention are not limited in this respect.

The representation of each family member may also have an associated label that includes other information, attributes or properties of the corresponding family member. Labels may include any one or combination of name, medical record number (MRN), date of birth, status (e.g., living/deceased), physical attributes, medical attributes, or any number of other attributes including any user-defined attributes that may be of interest. While exemplary family tree representation 300 illustrates only the immediate family relationships, any number of extended family members and family relationships may be included in the representation, as the aspects of the invention are not limited in this respect. As shown, graphical representation 300 includes a target family member 310, siblings 340 and 350 and parents 320 and 330, each of the family members showing relationship status on the associated label relative to target member 310.

In act 240, interaction instructions are received from the user via the graphical family tree representation to modify the family tree and/or the family tree representation. For example, the user may interact directly with the graphical family tree representation to make at least one modification to the family tree and/or the family tree representation. For example, the user may select or highlight a family tree member, add a new family member, add, modify or define attributes or properties for the family members, connect to a family member, delete a family member and/or customize display options, either as single operations or in any combination, as discussed in further detail below. Other interactions with the graphical family tree representation that modify at least some property of the family tree or family tree representation may be performed, as the aspects of the invention are not limited in this respect.

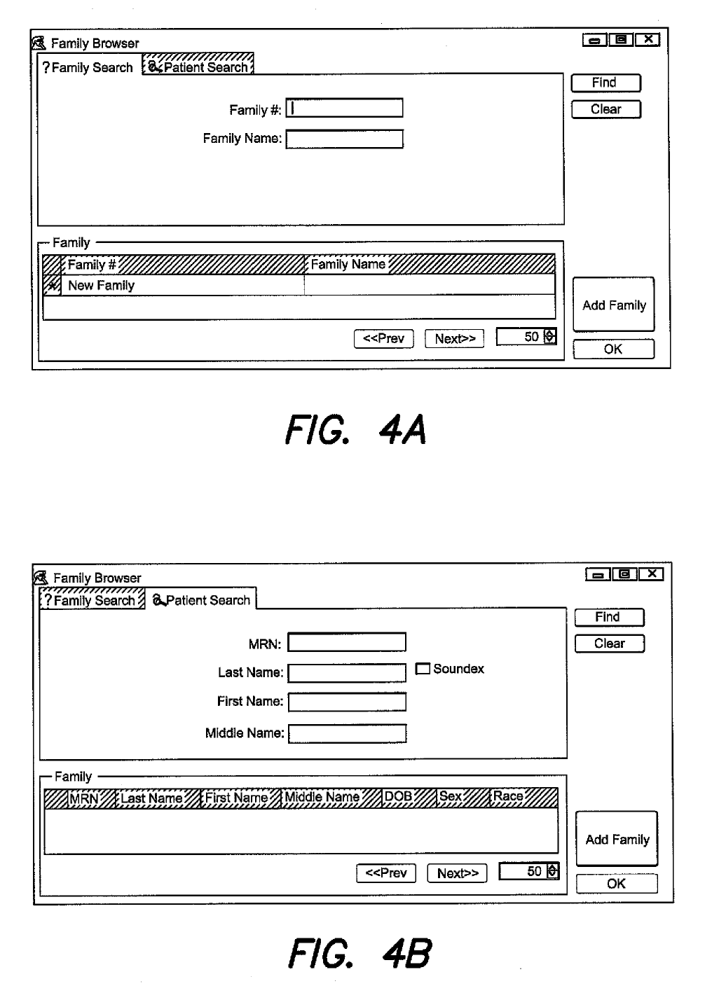

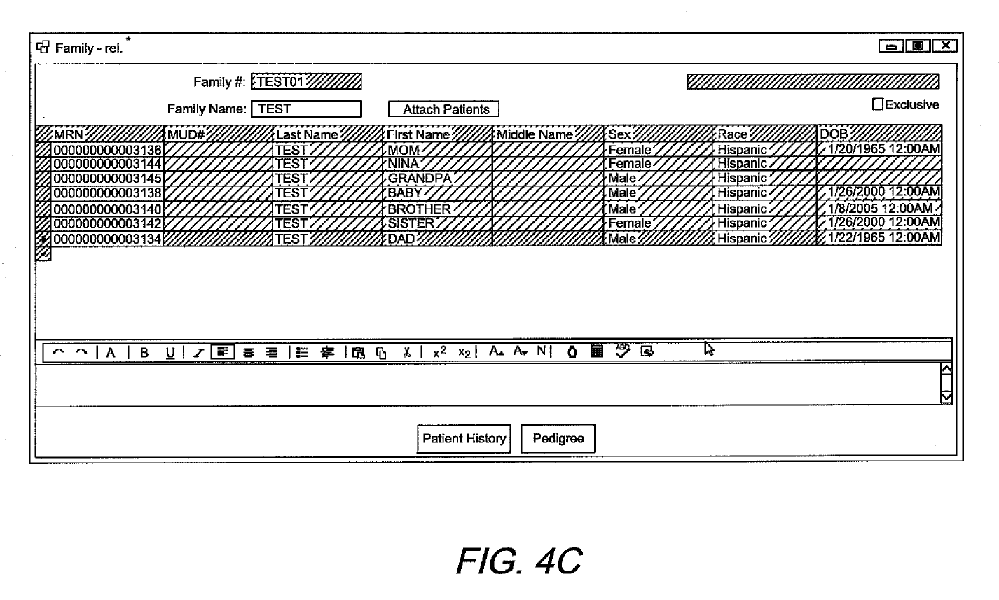

FIGS. 4-18 illustrate interface functionality provided by a dynamic family tree module adapted to build and allow interaction with a graphical family tree representation, in accordance with some embodiments of the present invention. As discussed above, a family tree module (e.g., module 110/110′) may provide interface functionality that permits a user to input information to create and build a family tree and/or search and obtain an existing family tree. As also discussed above, the family tree module may be integrated into an application that includes other functionality that may present further interface functionality, features and options to perform various other related tasks. However, the family tree module may alternatively be a standalone module that provides at least some of the family tree functionality described herein, as the aspects of the invention are not limited in this respect.

As discussed above, a family tree may be obtained by either creating and building a new family tree, identifying and retrieving an existing family tree, or a combination of both. For example, a family tree module may present interface functionality, such as a menu option, that allows the user to search for an existing family tree. FIGS. 4A and 4B illustrate search options in a family browser window that allows a user to find an existing family tree either by searching by family or by individual patient, respectively. For example, under the “Family Search” tab of the “Family Browser” window illustrated in FIG. 4A, a user may either search the database for a family using a family number that was established during creation of the family tree, or by using the family name. Upon pressing the “Find” button, the family tree module may search for the family or family members that meet the family criteria and present the results in the results window labeled “Family.”

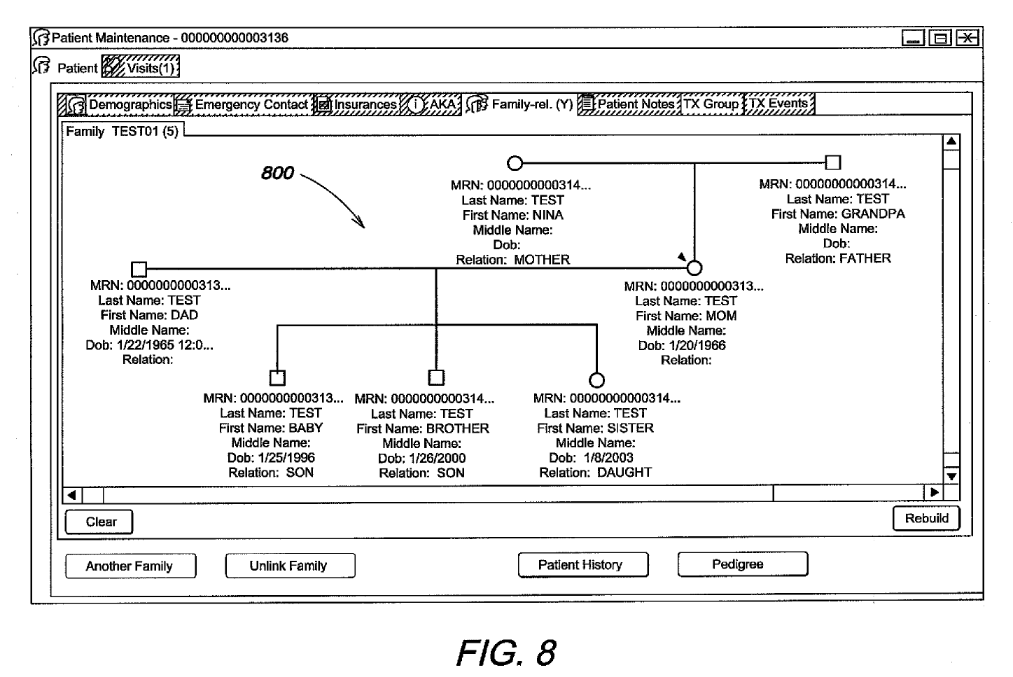

When a family is selected by the user, the family tree module may display a graphical representation of the family tree (see FIG. 8). FIG. 4C illustrates an example of a screen that may be presented in response to a user pressing the “Find” button after having entered TEST01 for the family number and/or TEST for the family name. The Family Relationship window displays the patients that meet the criteria, and allows the user to view the pedigree (i.e., the family tree) from the perspective of any of the patients. For example, selecting MOM TEST and pressing the “Pedigree” button causes the family tree module to display the graphical family tree representation shown in FIG. 8. Different and/or other interface functionality may be provided to assist a user in identifying and selecting an existing family tree for display, as the aspects of the invention are not limited in this respect.

A user may also search for an existing family using the “Patient Search” tab as illustrated in FIG. 4B. In particular, the user may search for a family associated with a patient using the medical record number (MRN), last name, first name and/or middle name of the patient as a search criteria. For example, assume that the user would like to display the family tree for MOM TEST. The user may provide this information in the corresponding fields to display any existing family relationships that might have been set up and archived in the database. After a user presses the “Find” button, the family tree module may, in response, display a “Family-rel.” window for the patient meeting the search criteria. If more than one patient meets the input criteria, the family tree module may present the user with all matches so that the user can select the desired patient.

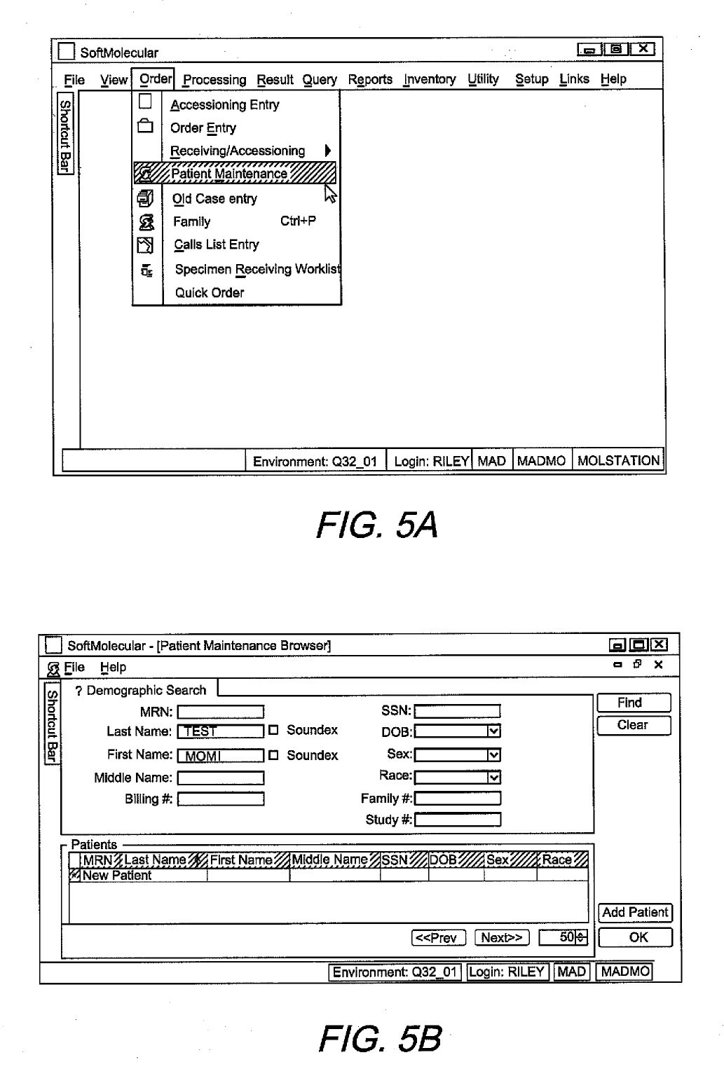

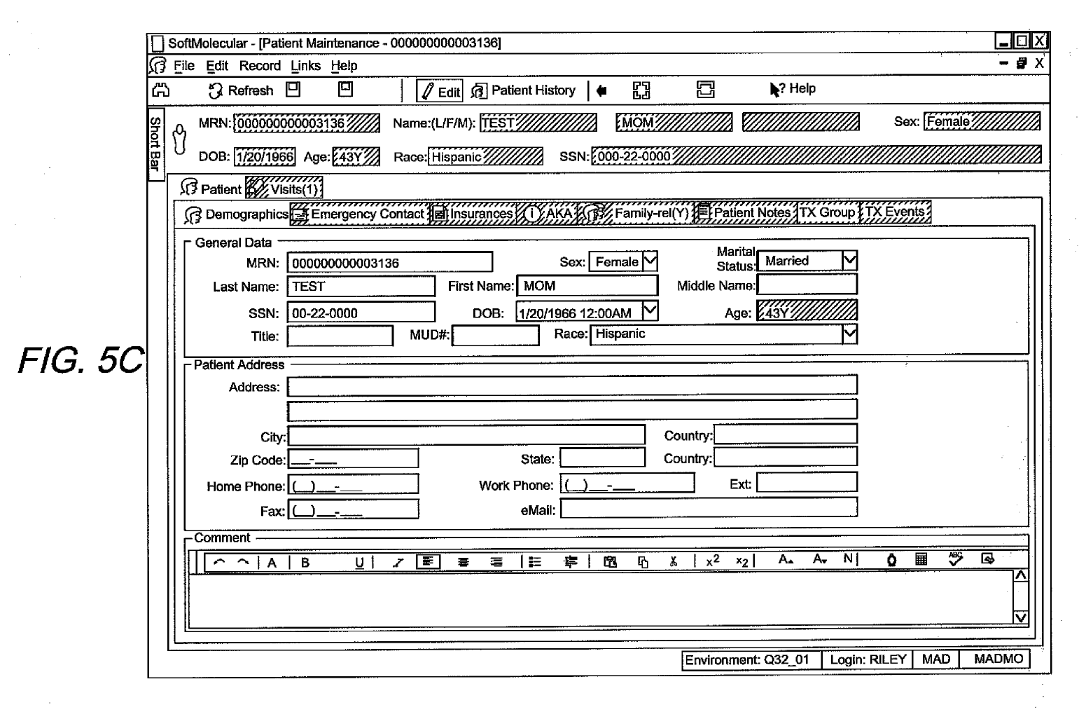

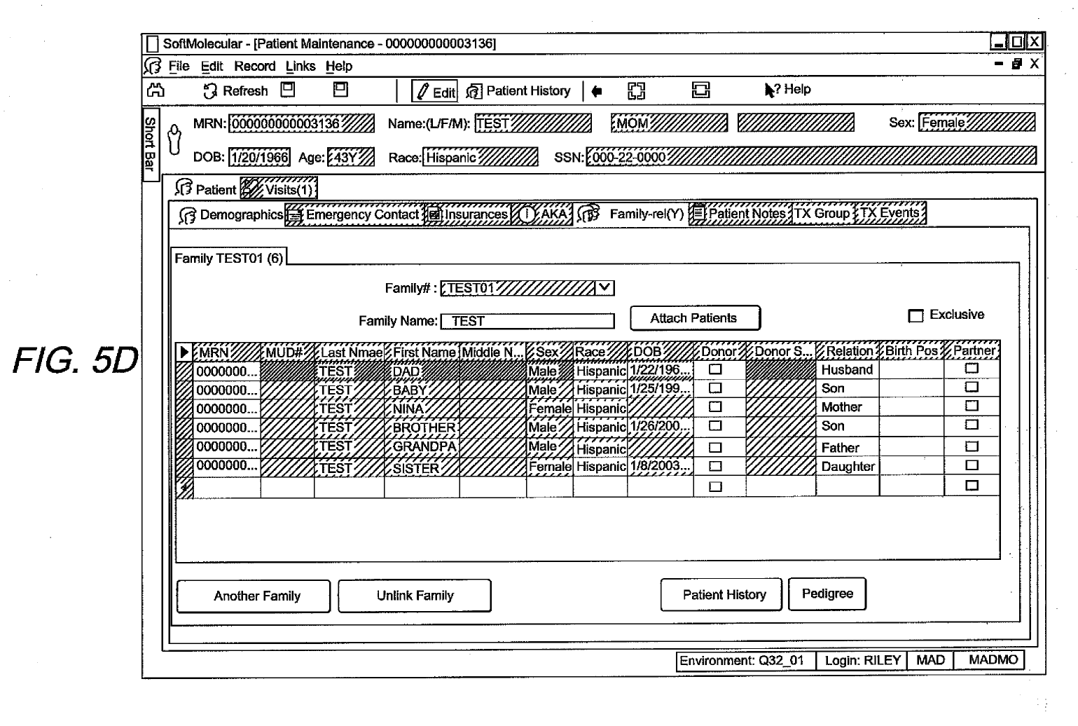

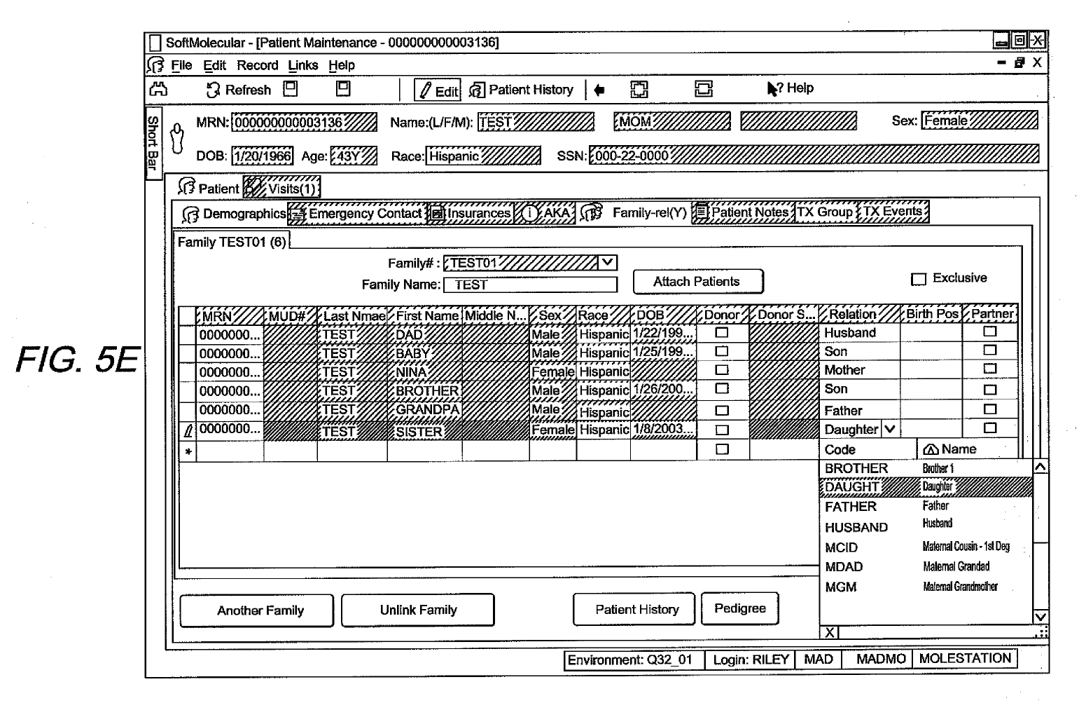

FIG. 5A illustrates one interface that provides a user the ability to indicate that the user would like to provide information about a family and/or family tree. In particular, the user is presented with a “Patient Maintenance” option from an “Order” pull-down menu on a toolbar customized for a particular non-limiting application. The “Patient Maintenance” selection may indicate to the family tree module that the user would like to input family information and/or relationships. FIGS. 5B-5D illustrate interface functionality that allows a user to obtain an existing family tree from the database, in accordance with some embodiments of the present invention. FIG. 5B illustrates a “Patient Maintenance Browser” that allows a user to search for a desired target family member. The user may search for the family member using any of the illustrated criteria (or other criteria) in the demographic search. In FIG. 5B, the user has indicated a desired search for family member MOM TEST.

In response to the user actuating the “Find” button, the family tree module may present patient information on the queried patient as illustrated in FIG. 5C. As shown in FIG. 5C, a “Family-rel.” tab is presented with an indication of whether family relationships have been defined for the selected family member. In this instance, the indication shows a “(Y)” to indicate that a family exists for family member MOM TEST, FIG. 5D illustrates the “Family-rel.” tab for the selected target family member. A graphical representation for the family tree may be displayed by actuating the “Pedigree” button, the result of which is illustrated in FIG. 8, as discussed in further detail below. FIG. 5E illustrates that the “Family-rel.” tab may include interface functionality that allows the user to specify the relationship between each family member and the target family member and/or to modify the relationships. It should be appreciated that an existing family may be obtained and/or modified in other ways, as the aspects of the invention are not limited in this respect.

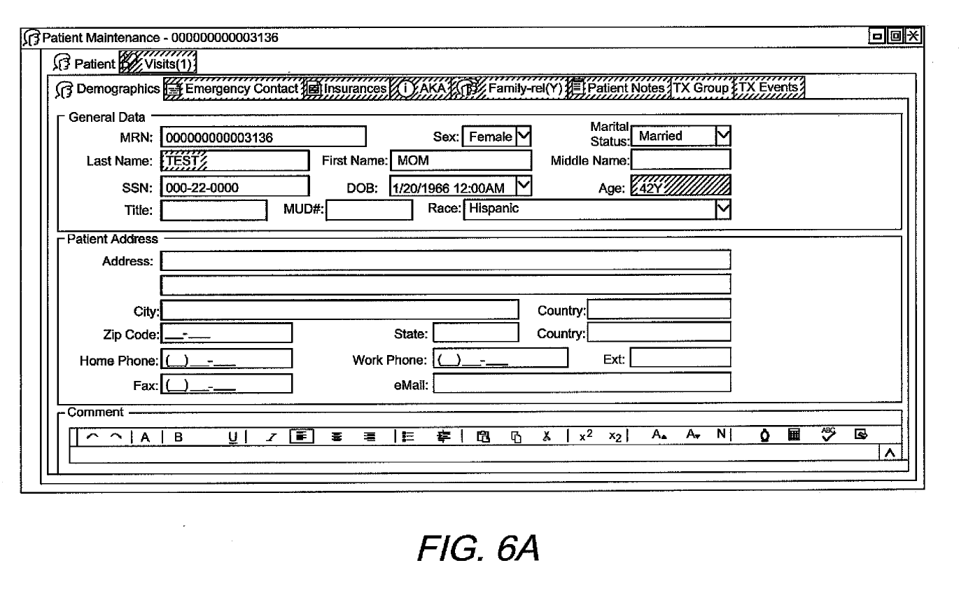

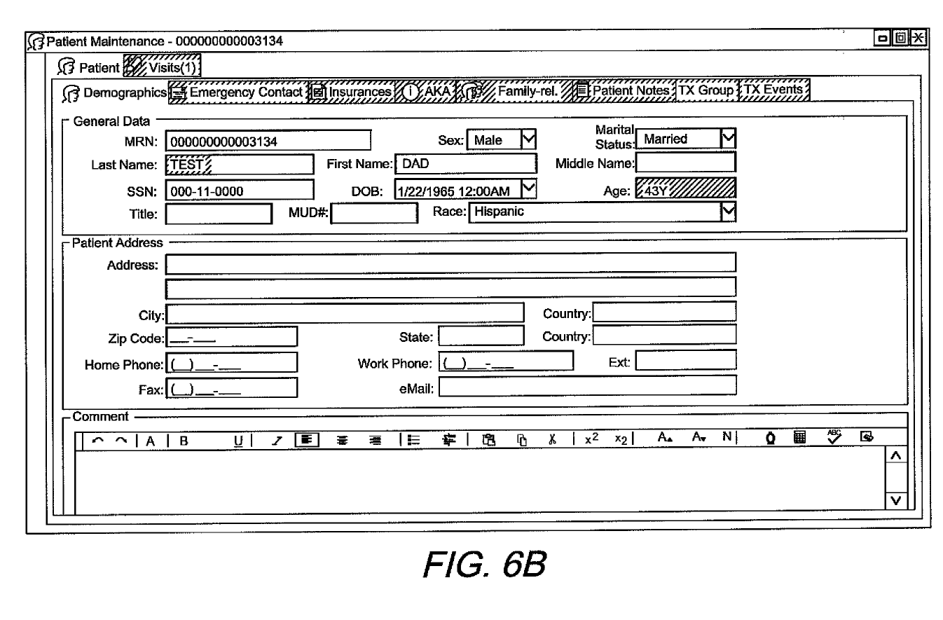

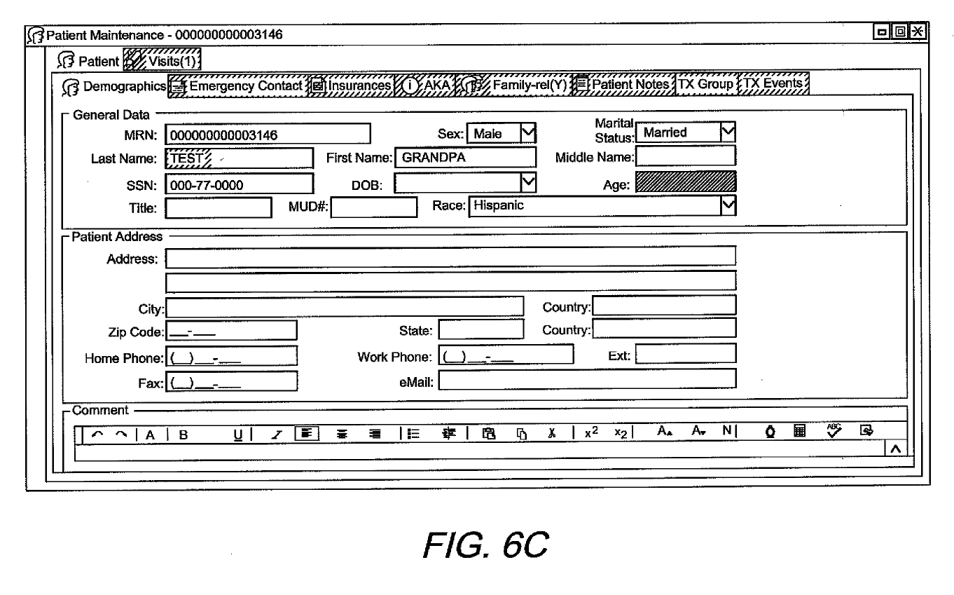

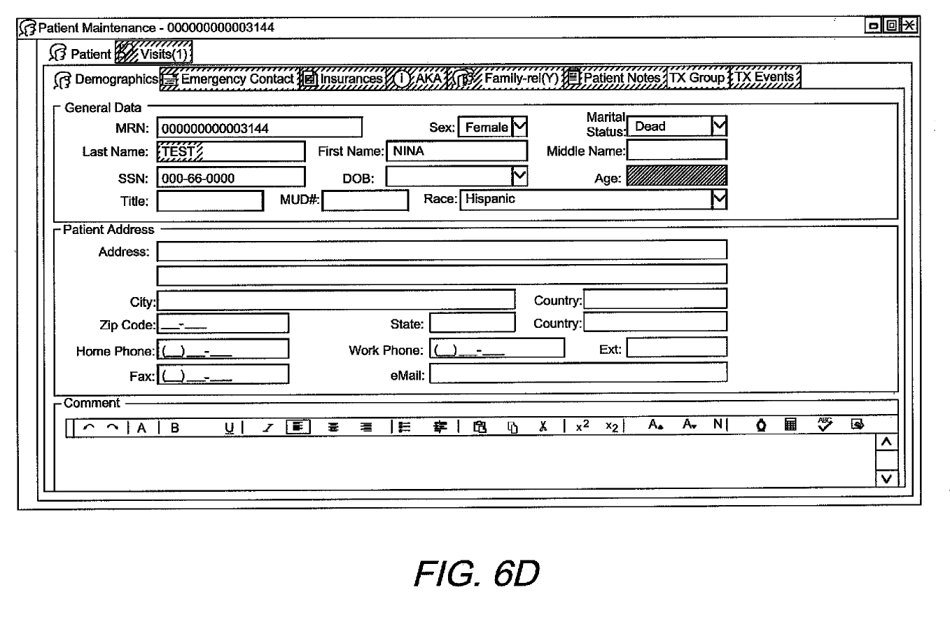

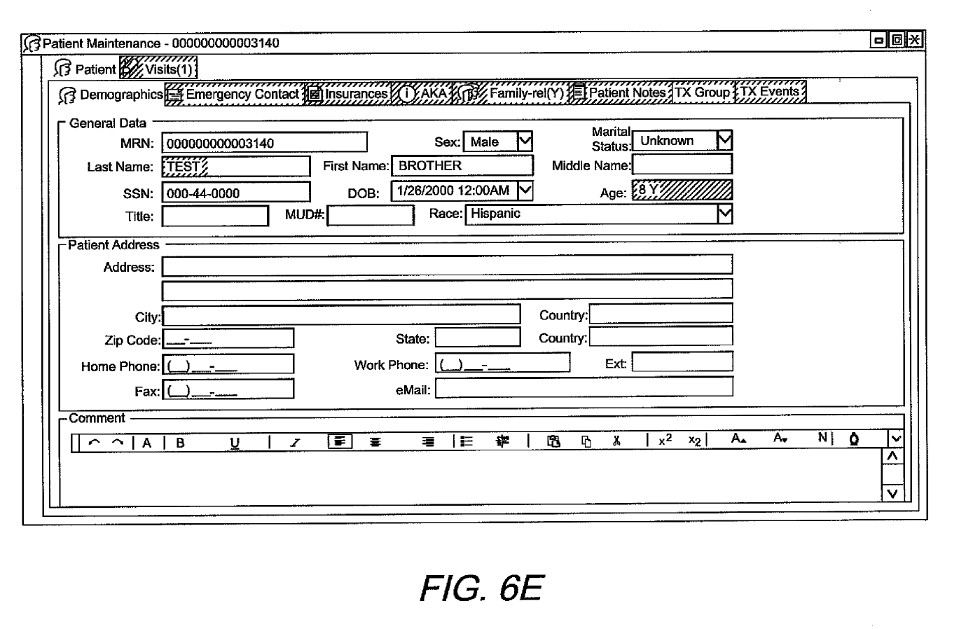

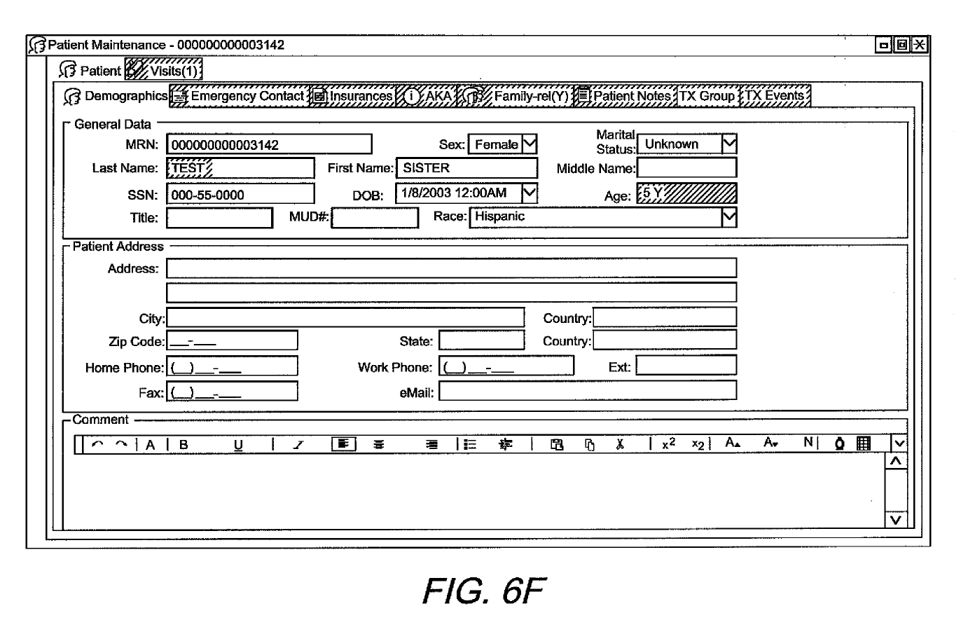

As discussed above, obtaining a family tree may be achieved by either searching for and selecting an existing family tree, or creating a new family tree and adding desired family relationships to the family tree. According to some embodiments, family members may be added via interface functionality and the relationships between these family members may be defined. For example, family members may be entered using the Patient Maintenance window described herein. FIGS. 6A-6F illustrate interface functionality for entering family member information via the Patient Maintenance window for some exemplary members of the TEST family. It should be appreciated that a user may enter as much or as little information about each family member as desired and/or as much or as little information that is known about each family member. The information entered by the user may then, if desired, be saved in the patient database. It should be appreciated that the interface functionality in FIGS. 6A-6F is merely exemplary and family member and/or family information may be received via any type of interface or interface functionality provided by the family tree module.

After a user has entered information for each desired family member, the user may search for the newly created family by using the Family Browser described above in connection with FIGS. 4A and 4B. For example, the user may open the Family Browser and use the family name TEST as the search criteria. In response to clicking on the “Find” button, the family tree module may display all individuals that meet the search criteria. Alternatively, the user may use the Family Browser to find and select a target member, which in response to a user selecting a patient found in the search, the family tree module may display the Patient Maintenance window for the selected target family member. That is, once family members have been input in some manner, the family members may be displayed such that family relationships amongst the family members may be established and/or defined.

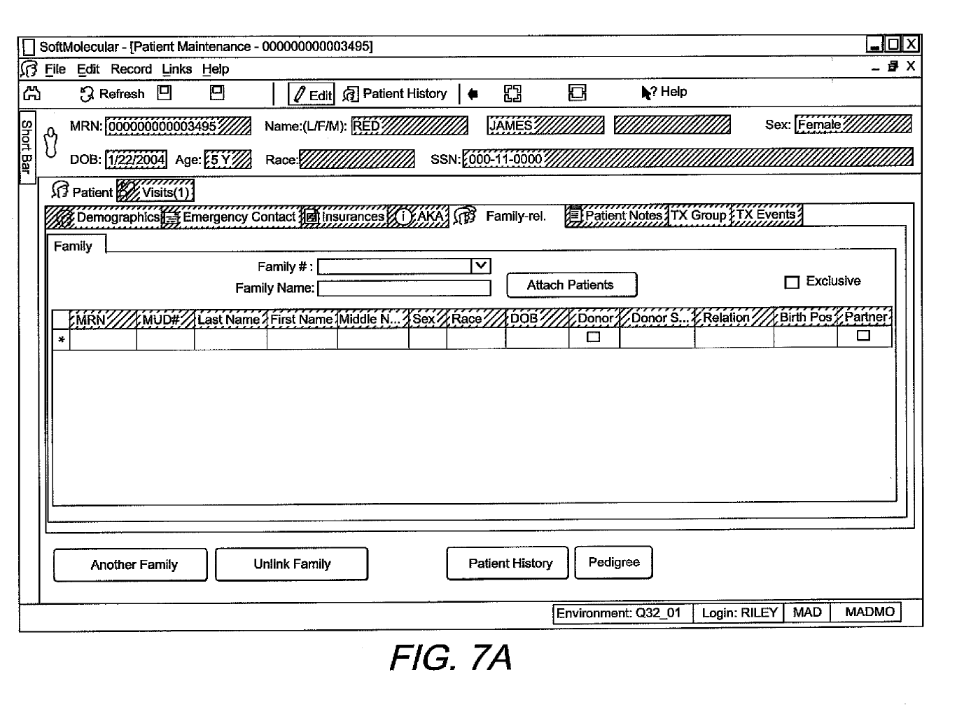

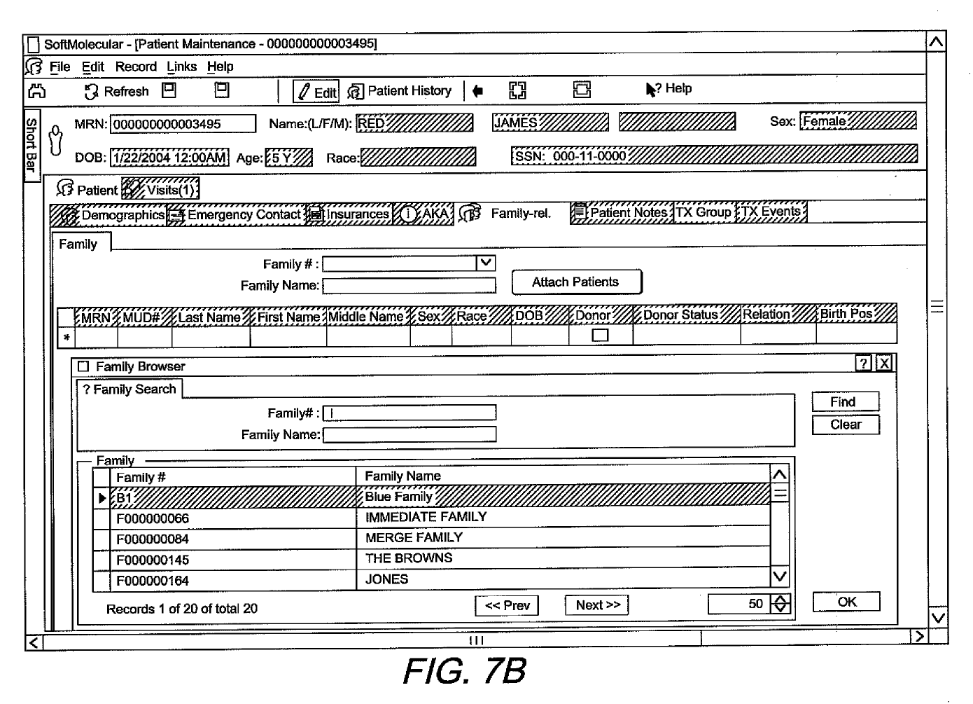

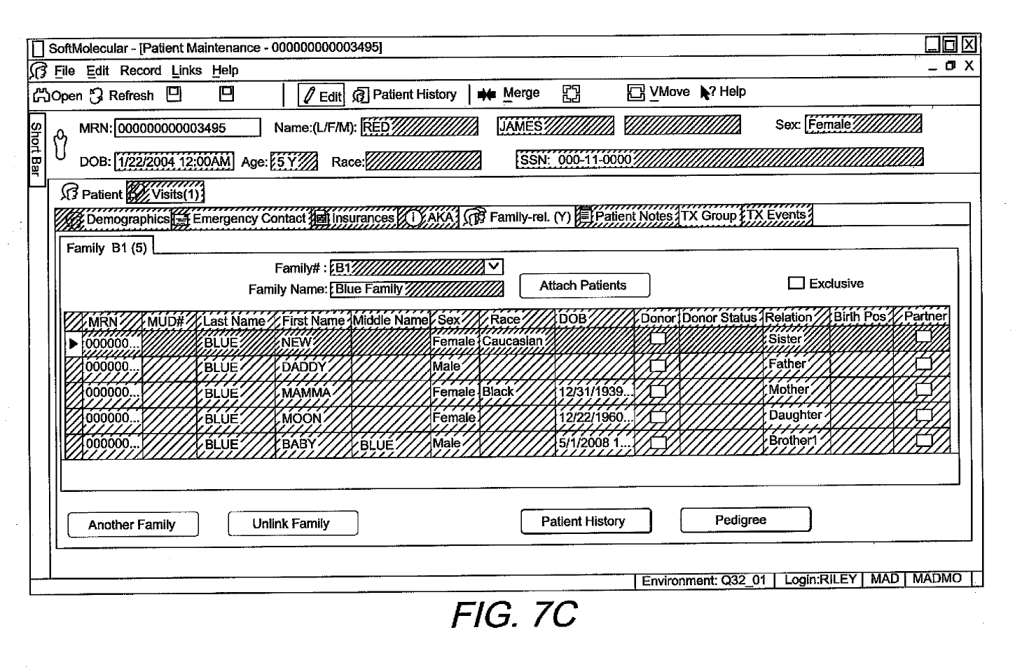

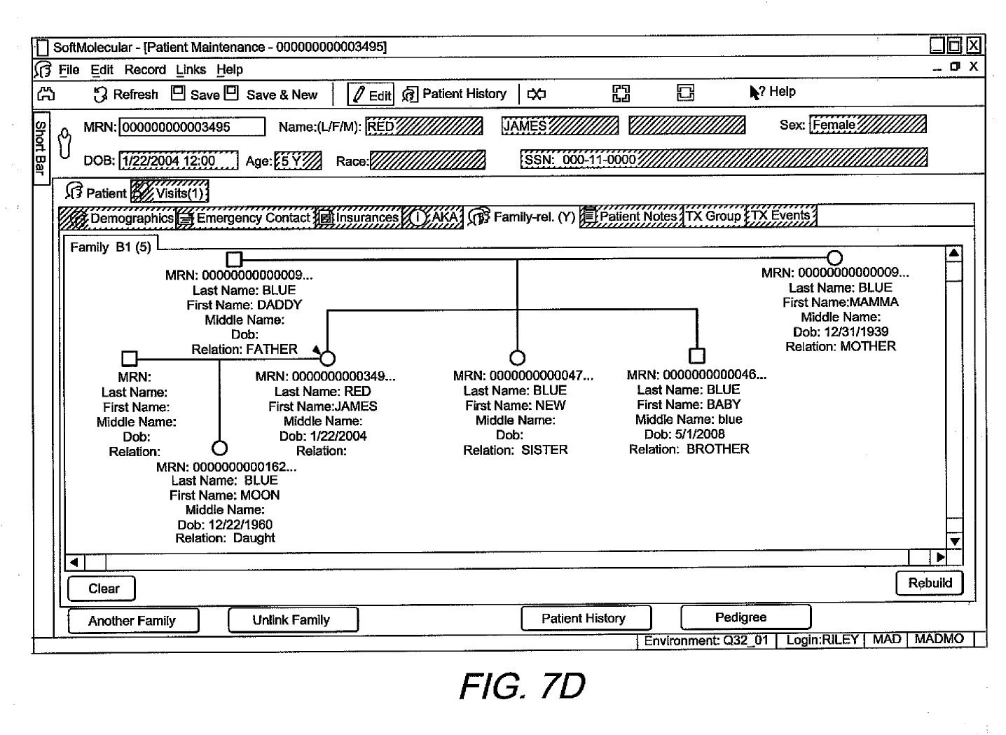

As discussed above in connection with FIG. 5C, the selected family member (MOM TEST) was indicated as having an existing family relationship. However, in some instances, a patient may not have a family already defined for it. In such instances, it may be useful to present interface functionality to allow a user to add a target family member to an existing family for which the patient was not previously affiliated. FIG. 7A illustrates a patient JAMES RED that was selected via a patient query. The “Family-rel.” tab does not include an indication that a family exists, and consequently no family members appear when the “Family-rel.” tab for JAMES RED is selected. By clicking on the blank family member, the family tree module may present a list of existing families that JAMES RED may be linked to as shown in FIG. 7B. FIG. 7C illustrates a window provided by the family tree module in response to the user selecting the BLUE family with which to add JAMES RED. As discussed above in connection with FIG. 5E, the user may define the family relationships using the “Family-rel.” tab. By actuating the “Pedigree” button, a graphical representation of the BLUE family may be displayed as illustrated in FIG. 7D.

In addition, from FIG. 7A or 7D, the user may select to attach a new patient to the family using the “Attach Patients” button. In addition, the user may specify the relationship between each family member and the target family member as also illustrated in FIG. 7A. Accordingly, a user may be able to define and associate family relationships via the family tree module. By actuating the “Pedigree” button, the family tree module may display a graphical representation of the family tree established according to the defined family relationships for the target patient, as illustrated by the exemplary representation in FIG. 8. It should be appreciated that user designated family members may be associated and linked in other ways, as the aspects of the invention are not limited in this respect.

It should be further appreciated that the interface functionality described above and illustrated in FIGS. 4-8 is merely exemplary. Family tree information may be received, queried and obtained in any fashion to facilitate display and interaction with a representation of the family tree, as the aspects of the invention are not limited in this respect. The type of interface functionality provided by the family tree module may depend on whether the family tree module is a standalone application or an integrated software component of a larger application, and, if the latter, may depend on the interface functionality of the larger application and/or the other components that comprise the application. The interface functionality may be designed to facilitate input/retrieval of family tree information in any way that the software designer sees fit to, for example, achieve a generally intuitive and flexible interface in the context of the specific family tree module, and to provide a means for creating, building and/or retrieving a family tree, and for displaying a representation of the family tree.

FIG. 8 illustrates a graphical representation of the family tree established using any of the above described interface functionality to either build a family tree or obtain/retrieve an existing family tree for display. In family tree representation 800, each individual is depicted by either a circle or a square depending on gender and generations are denoted from the furthest represented ancestor at the top level of the tree and continuing down through successive generations. Each graphical icon or node denotes a member of the family tree and has an associated label. In family tree representation 400, the label displays the family member's MRN number, name, date of birth and relationship to the target family member. However, any information may be displayed on the label by default and/or as defined or customized by the user, as discussed in further detail below. As shown, MOM TEST is the target family member so that relationships are shown relative to the target member.

As discussed above, conventional family tree representations are static. Once they are displayed, the user may not be able to interact with the family tree. To modify a family tree according to conventional methods, the family tree information may need to be input from scratch with the necessary modifications performed during input. However, such static family tree representations are inconvenient to work with and impose relatively significant work on the user should a family tree need to be updated, modified or changed in view of new information and/or error in creating or building the family tree. Applicant has appreciated that by providing interface functionality directly on the family tree representation, a user may interact, update and/or modify a family tree and/or family tree representation via the displayed family tree representation. The family tree may be modified and a representation of the modified family tree may be displayed in real time as the user interacts with the family tree.

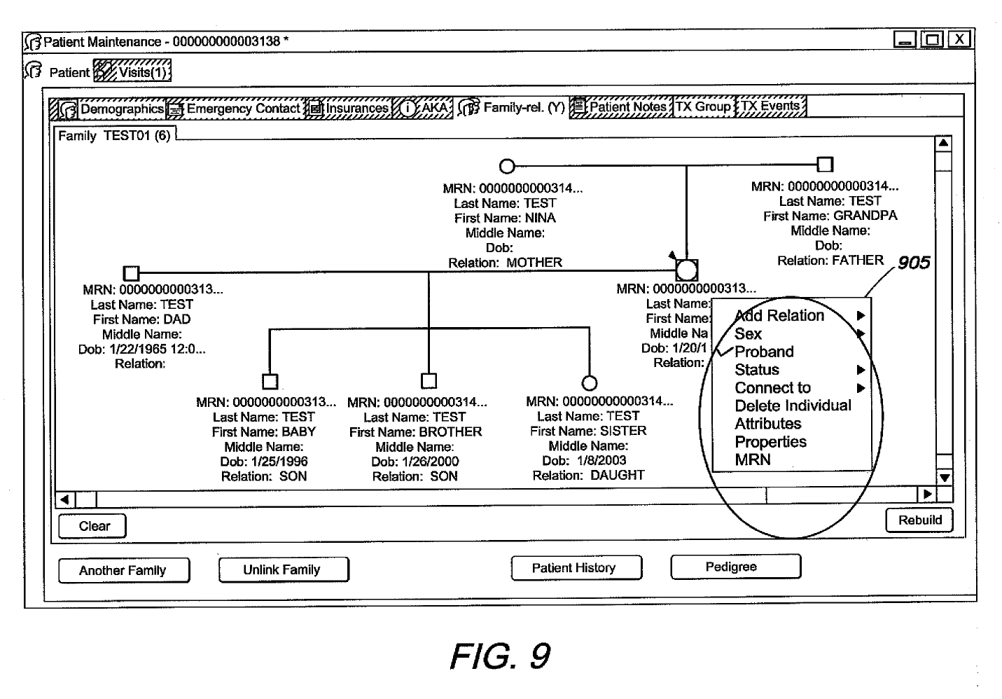

FIGS. 9-18 illustrate non-limiting examples of modifications that may be performed on the family tree via the representation of the family tree displayed to the user, in accordance with some embodiments of the present invention. As illustrated in FIG. 9, any desired member of the family tree may be selected. For example, a family tree member may be selected by clicking with a mouse on the graphical icon for the desired family member. If a touch-screen is used, a family tree member may be selected by touching the graphical icon for the desired family member. Shortcut keystrokes, voice commands or any other interface method may be used to select a desired family member. In response to selecting a family member, the family tree module may update the family tree representation to indicate that the corresponding family member has been selected. For example, the color of the graphical icon associated with the selected member may be changed, or the graphical icon may be highlighted or otherwise emphasized to indicate selection. Arrows or other graphics may also be used, as the aspects of the invention are not limited for use with any particular type of selection indicator.

FIG. 9 illustrates the family tree representation after the target family member (MOM TEST) has been selected and the user has right clicked using a mouse or otherwise indicated that the user would like to view further options for the selected family member. As a result of the user's interaction with the family tree representation, the user is presented with a menu of options. For example, the family tree module may receive an indication that the user would like to view options for the selected family member and, in response, display a menu to the user for further interactions with the family tree.

In FIG. 9, the family tree module responds to the user's interaction by displaying menu 905, which lists a number of further operations that may be performed with respect to the family tree and more particularly with respect to the selected family member. The options listed in menu 905 are merely exemplary and may include fewer, more or different operations that may be performed on the family tree and/or the family tree representation. In the example shown in FIG. 9, the selected family member is both the target member and the proband. The proband refers generally to an individual or member of a family being studied in a genetic investigation, and may be an affected individual identified independent of relatives in a genetic investigation or study. However, the proband need not be the same as the target family member, as the aspects of the invention are not limited in this respect.

Add Relation

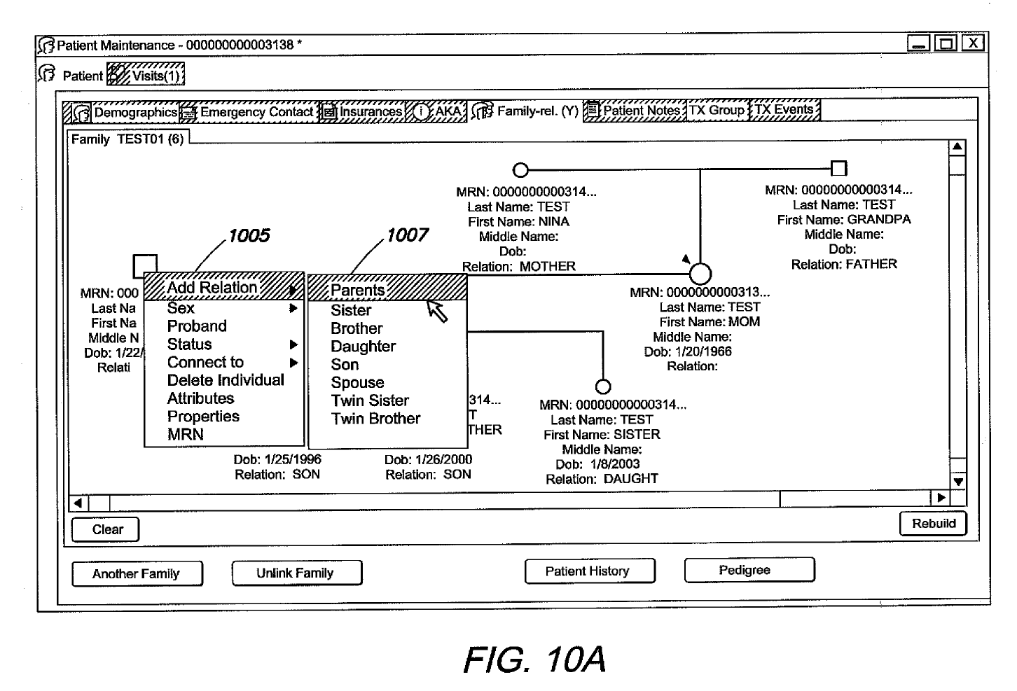

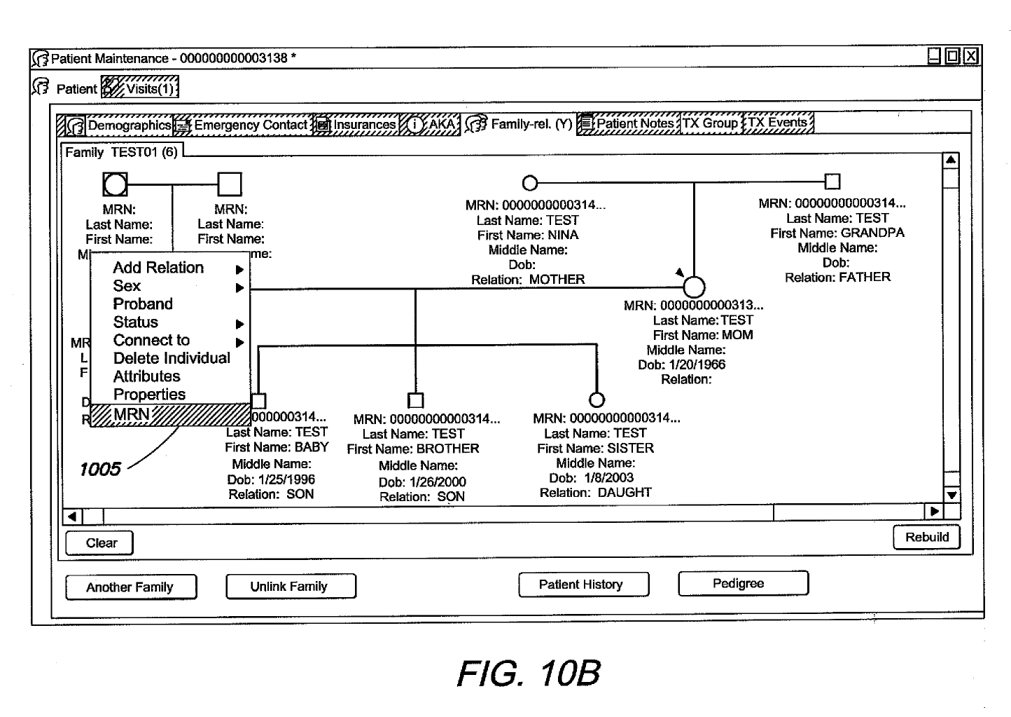

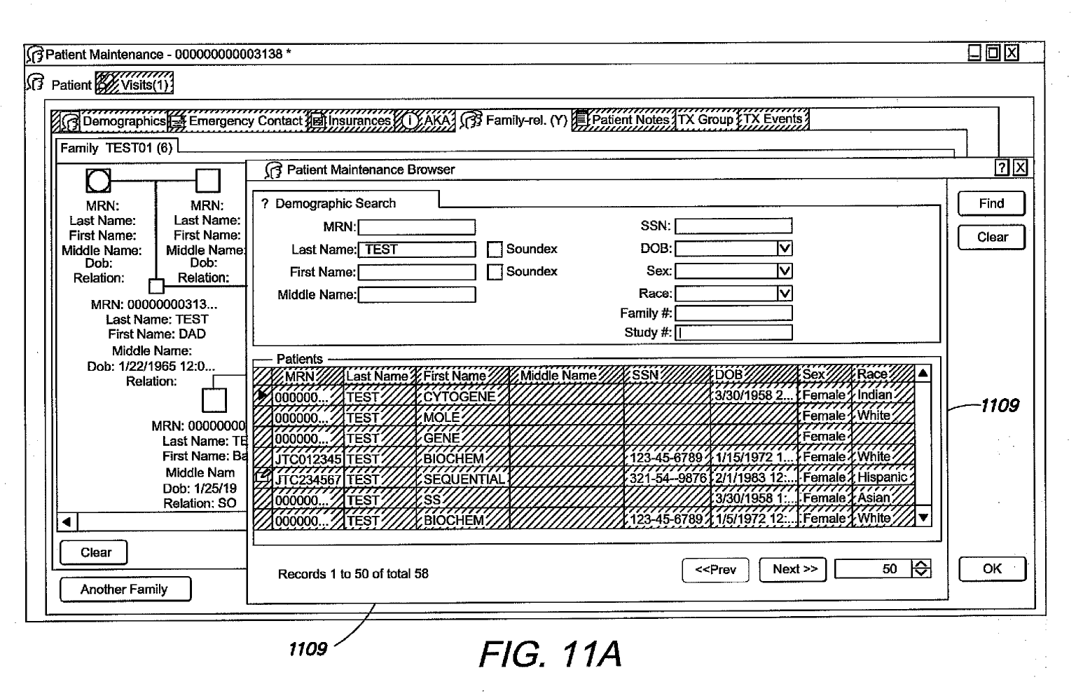

FIG. 10A illustrates an add relation operation that can be performed by a user-initiated action directly applied to the family tree representation. For example, a user may select a desired family member and then indicate that the user would like to view options with respect to the selected family member. The family tree module may, in response, highlight the selected family member and display a menu of available options to the user, respectively. In FIG. 10A, the user has selected TEST DAD and indicated that the user would like to view options with respect to this member. The user has then selected the “Add Relation” option from menu 1005, which in turn presents a list of relationship types from which the user may select. In FIG. 10A, the user has selected the “Parents” option under the “Add Relation” menu 1007, the result of this operation is illustrated in FIG. 10B.

That is, in response to receiving the indication that the user would like to add parents to TEST DAD in the family tree, the family tree module may update the family tree with a father and a mother for TEST DAD, and display the modified family tree to the user. In FIG. 10B, the modified family tree now has a graphical representation for the parents of TEST DAD. In response to the “Add Relation→Parents” option, the family tree module may present a template for a mother and a father for the selected family member. To allow a user to establish information for the added family members, the family tree module may allow the user to input information about the newly added family members directly via the family tree representation. For example, the user may select the mother of TEST DAD and right click to view additional options. In FIG. 10B, the user has selected MRN from menu 1005 such that the MRN number of the newly added mother may be input. Any other information, properties or attributes may be entered as well by interacting with the representation of the family tree, as discussed in further detail below.

As discussed above, information may be added to family members directly via the representation by providing a user with one or more interfaces that allow the user to input the associated information. This approach may be most suitable when information about family members does not already exist, for example, when family member information is not currently stored in a patient database. However, in some instances, a family member (e.g., a family member added via an interface of the representation) may already exist in the database. As a result, some or all of the desired information about the family member may already exist and the family tree module may automatically populate the label with the available information.

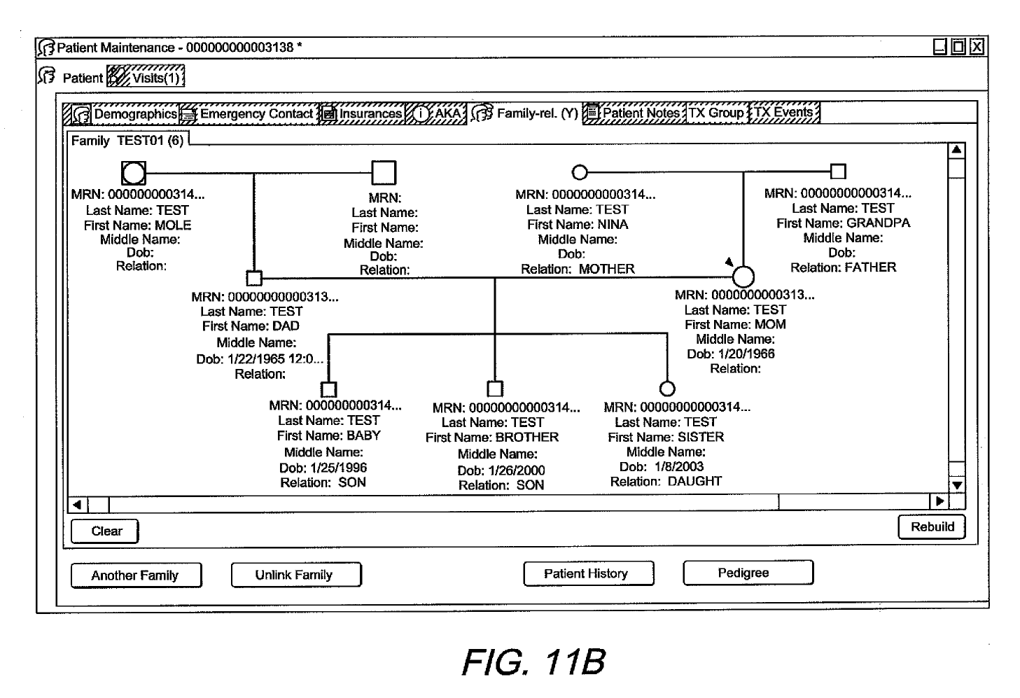

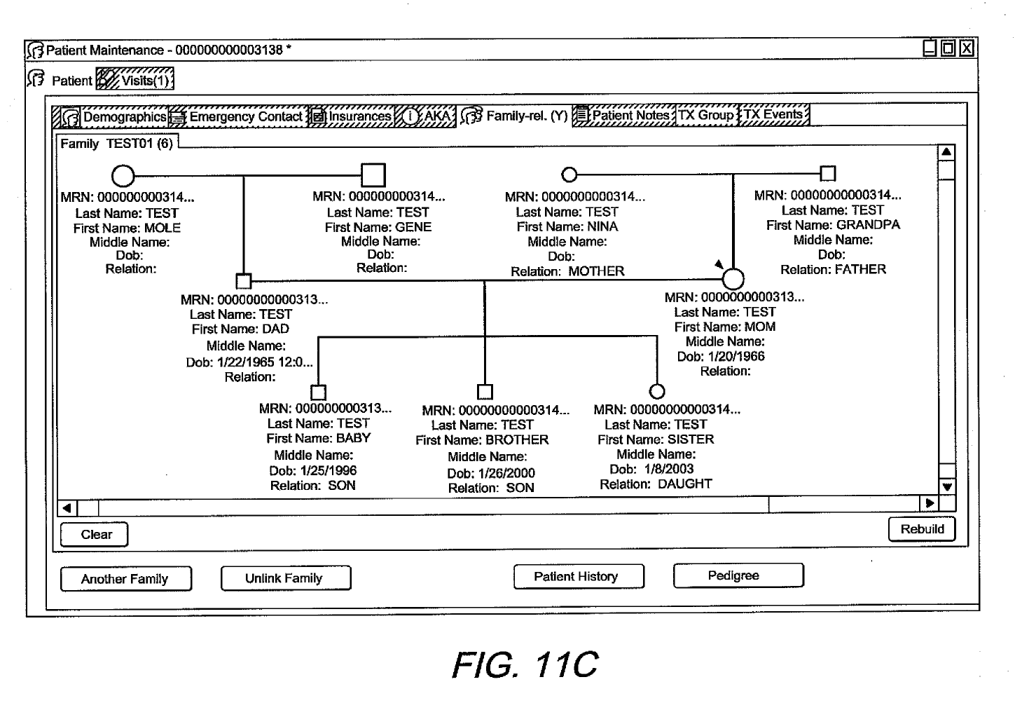

FIG. 11A illustrates an interface that may be presented to a user to allow the user to search for a family member in the database to automatically populate at least some information associated with the family member. In FIG. 11A, the mother of DAD TEST is selected and a demographic search window is presented in response to the user indicating that the user would like to search for the selected family member in the database. The demographic search window may contain any search fields desired. Demographic search window 1109 includes search fields for MRN, name, social security number (SSN), date of birth (DOB), sex, race, family number and study number. However, any field may be included to facilitate the user in finding the desired family member, as the aspects of the invention are not limited in this respect. In FIG. 11A, the user has chosen to search on the field “Last Name” and has typed in the last name (‘TEST’) of the family represented graphically in FIG. 8 in the “Last Name” field. The search on the last name “TEST” produced 58 records matching the query.

FIG. 11B illustrates the result after the user selected “MOLE TEST” from the results of the demographic query. As shown, the information in the database for MOLE TEST is presented on the label associated with the mother of DAD TEST. It should be appreciated that if more information about MOLE TEST (or any selected family member) were stored in the database, such information may also be automatically populated on the label associated with the family member. FIG. 11C illustrates the results of performing the demographic search described above for the father of DAD TEST after the user selected GENE TEST as the father of DAD TEST.

Connect to Relation

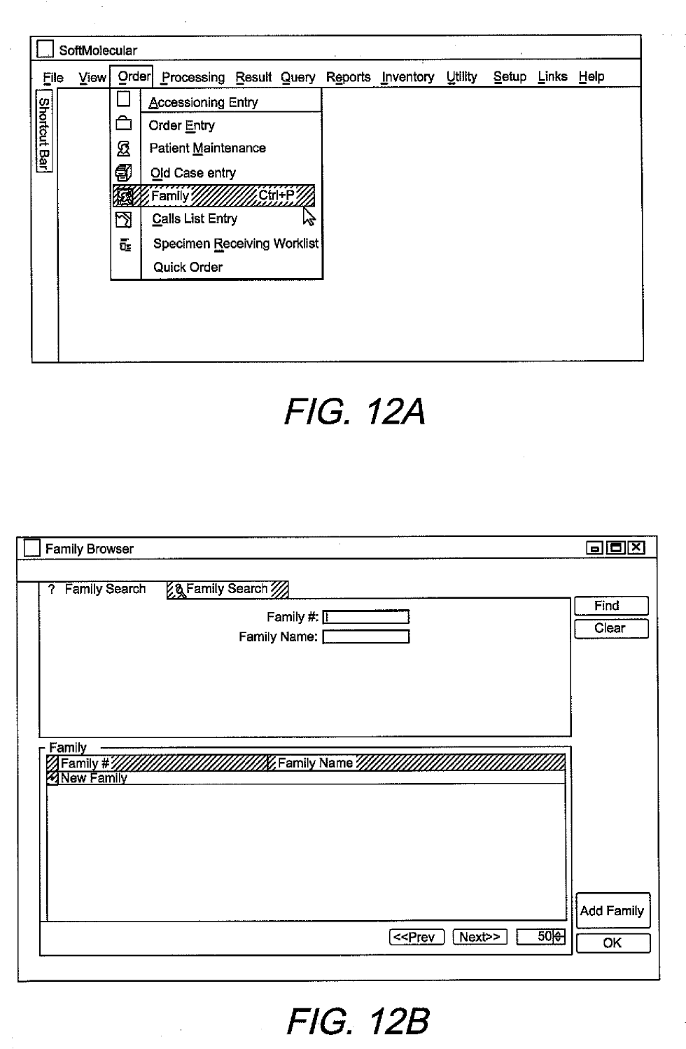

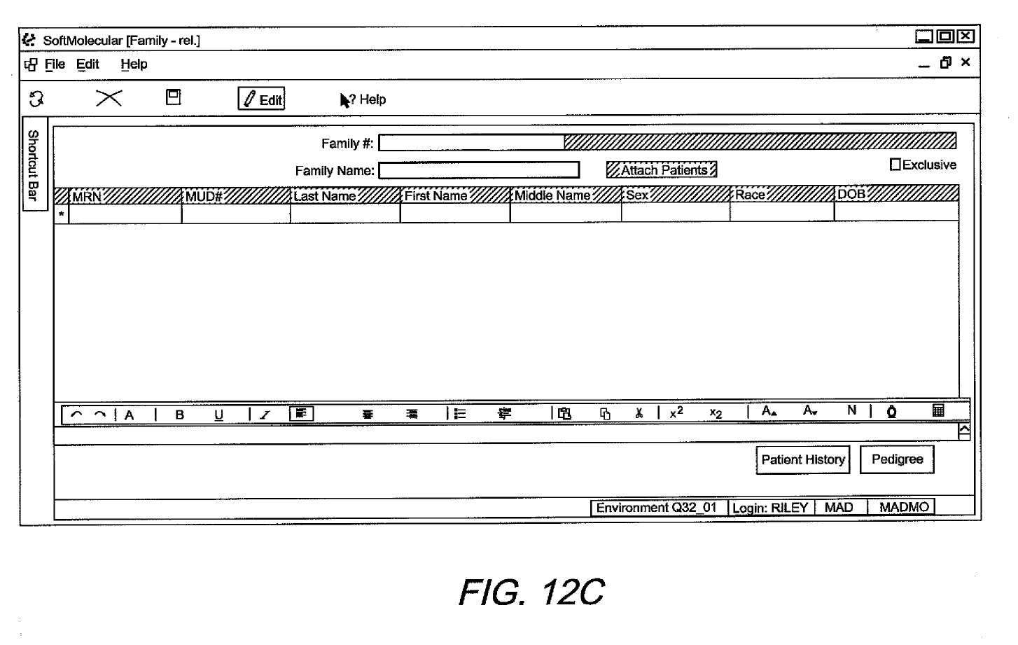

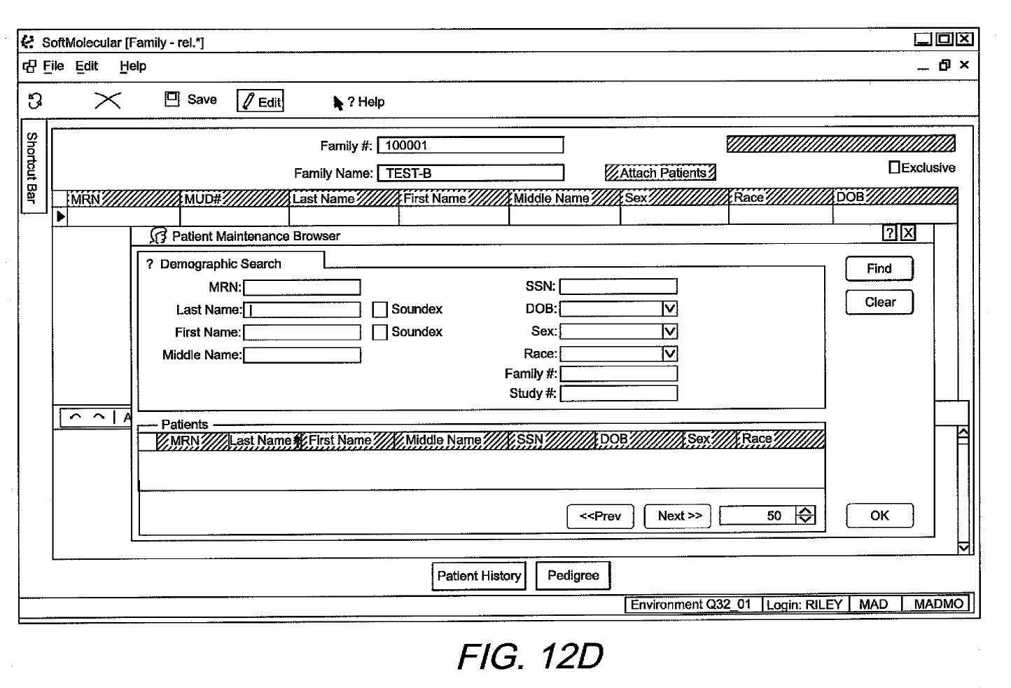

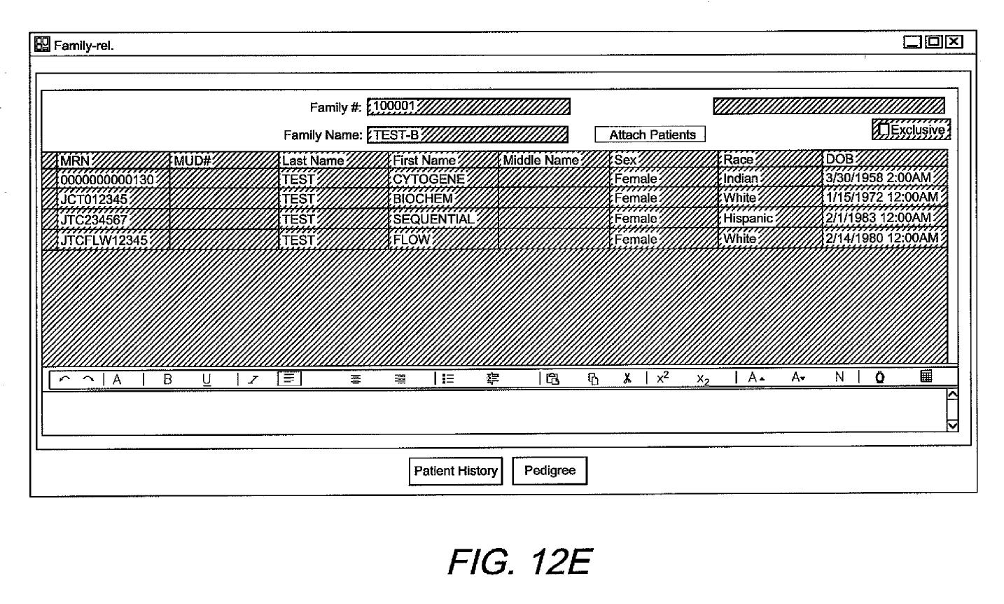

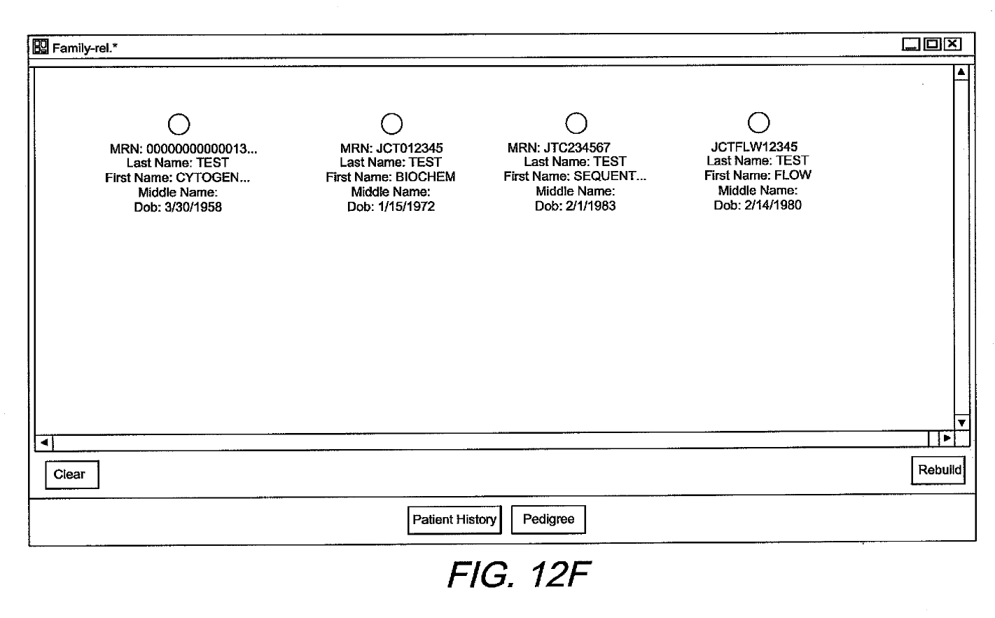

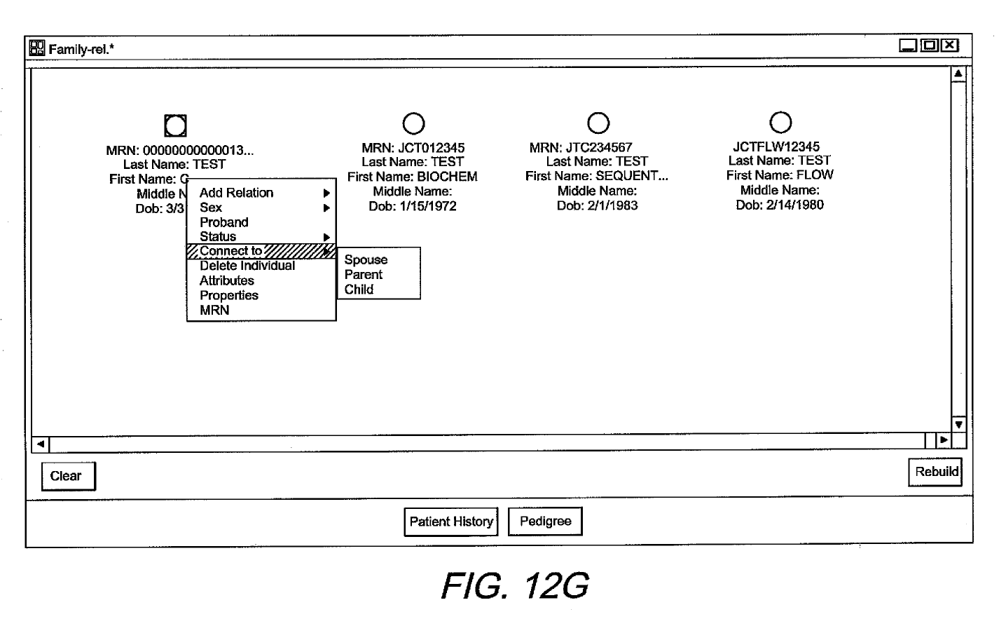

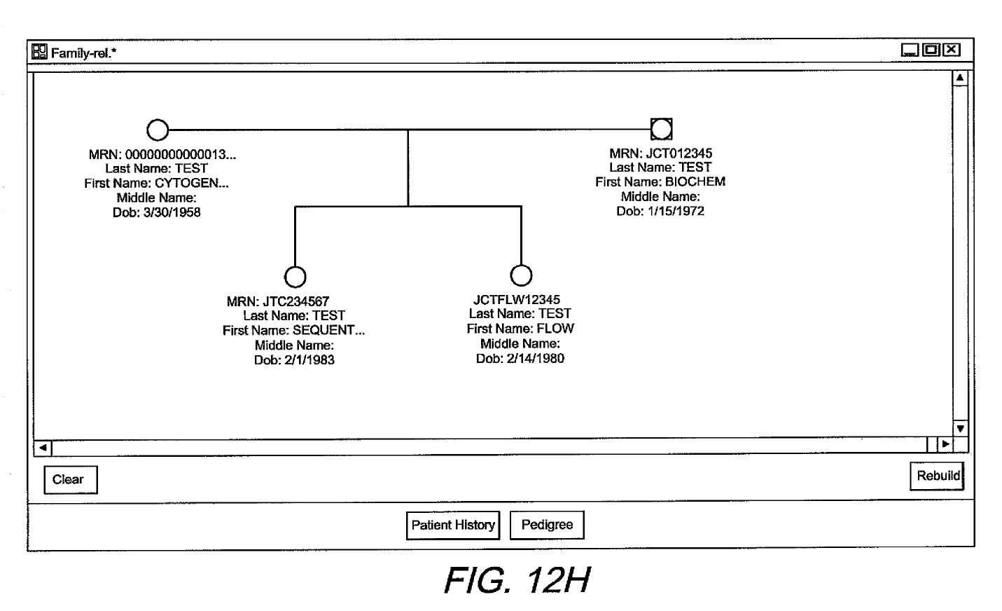

Applicant has appreciated that allowing a user to connect or link to an already existing family member may facilitate a flexible, intuitive and convenient family tree representation. FIGS. 12A-12H illustrate interface functionality to allow a user to connect to or link family members in the context of building a new family and establishing family relationships, in accordance with some embodiments of the present invention. As discussed herein, a user may be provided with any type of functionality to allow the user to build and specify a family to establish a family tree. FIG. 12A illustrates one interface that provides a user the ability to indicate that the user would like to provide information about a family and/or family tree. In particular, the user is presented with a “Family” from an “Order” pull-down menu of a toolbar customized for a particular non-limiting application. The “Family” selection may indicate to the family tree module that the user would like to input family information and/or relationships.

FIG. 12B illustrates a “Family Browser” window that may be presented to the user upon selecting the “Family” option in FIG. 12A. As discussed above, a user may search for existing families using the family number and/or family name. In addition, a user may create a new family using the “Add Family” button on the “Family Browser” window. FIG. 12C illustrates a “Family-rel.” window resulting from a user selecting the “Add Family” button. As shown, the “Family-rel.” includes an “Attach Patients” button that allows a user to attach patients to the family being created. FIG. 12D illustrates a “Patient Maintenance Browser” presented to the user by the family tree module to allow the user to search for a family member in the database to add to the family being created. A user may use any of the designated demographic criteria (or any other criteria) to search for the desired family member.

FIG. 12E illustrates a number of family members that have been added through the search functionality provided by the “Patient Maintenance Browser” illustrated in FIG. 12D. Because there is no target family member defined and no relationships have yet to be established, the listed family members are simply listed as being part of the TEST-B family, but without family relationships. Even without defining the relationships and/or establishing a target family member, a graphical representation of the family may be displayed by actuating the “Pedigree” button on the “Family-rel.” window. FIG. 12F illustrates a graphical representation of the family created as shown in FIGS. 12A-12E. There is a graphical icon for each node representing the family members added to the family. However, because no relationships have been defined, there are no edges in the representation. Applicant has appreciated that allowing the user to connect and/or link family members via the representation may facilitate a flexible and effective means for making the family tree representation interactive.

FIG. 12G illustrates the family tree created as shown in FIGS. 12A-12E. In FIG. 12G, the user has selected family member CYTOGENE TEST and indicated that the user would like to view the options menu. From the options menu, the user may select the “Connect to” option which provides relationship options listing the relation the user would like to use for the connection. Thus, the “Connect to” option allows a user to add edges to the family tree representation to depict the desired family relationships. FIG. 12H illustrates the result of using the “Connect to” option to define the spousal and child relationship illustrated in the graphical family tree representation.

Accordingly, the user may be able to establish relationships via direct communication with the representation of the family tree, and also may be able to quickly set up relationships with patients that are already stored in the patient database, allowing for quick and easy expansion of family relationships that are maintained and stored in the patient database and/or define the relationships of a newly created family. The ease of expanding family relationships may simplify understanding relatively complex relationships between existing patients in a family study.

Delete Relation

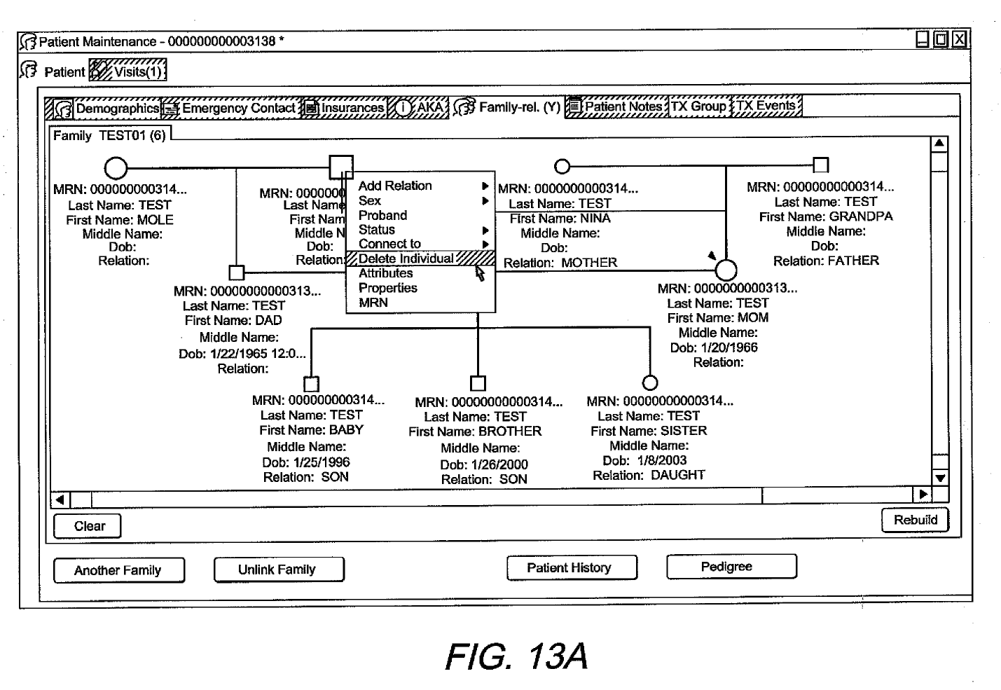

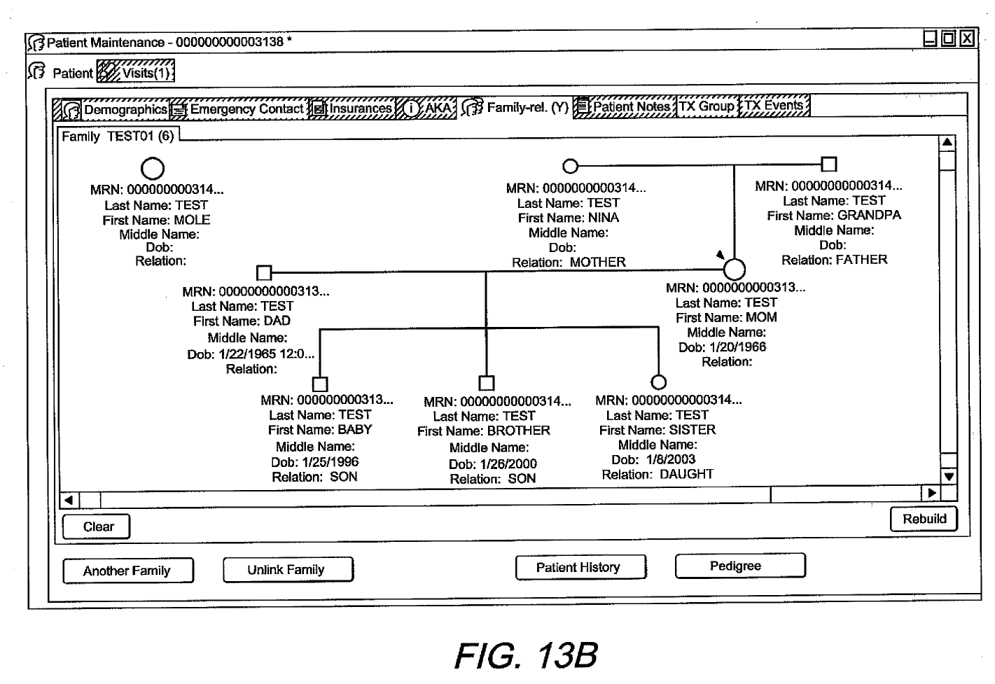

In some circumstances it may be useful to remove a member from a family tree. Applicant has recognized that allowing a user to delete a member from the family tree may facilitate a more flexible and interactive interface to family tree representation and visualization. FIG. 13A illustrates a user having selected a family member to delete and the user subsequently requesting, via the interface, to be presented with the options menu. From the options menu the user may select the “Delete Individual” option to delete the selected family member from the family tree. FIG. 13B illustrates a representation of the family tree after the selected family member (GENE TEST) has been deleted. That is, after the user indicates that the selected family member should be deleted from the family tree, the family tree module may respond by deleting the family member as well as the corresponding relationships from the family tree and displaying a representation of the modified family tree, as illustrated in FIG. 13B.

Editing and Setting Attributes and Properties

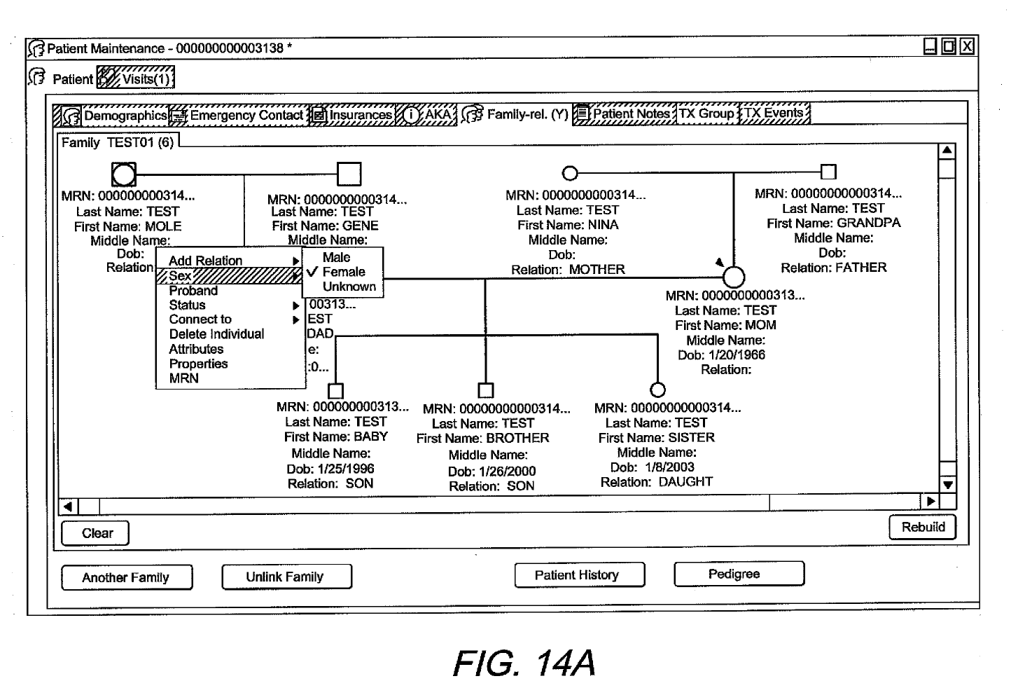

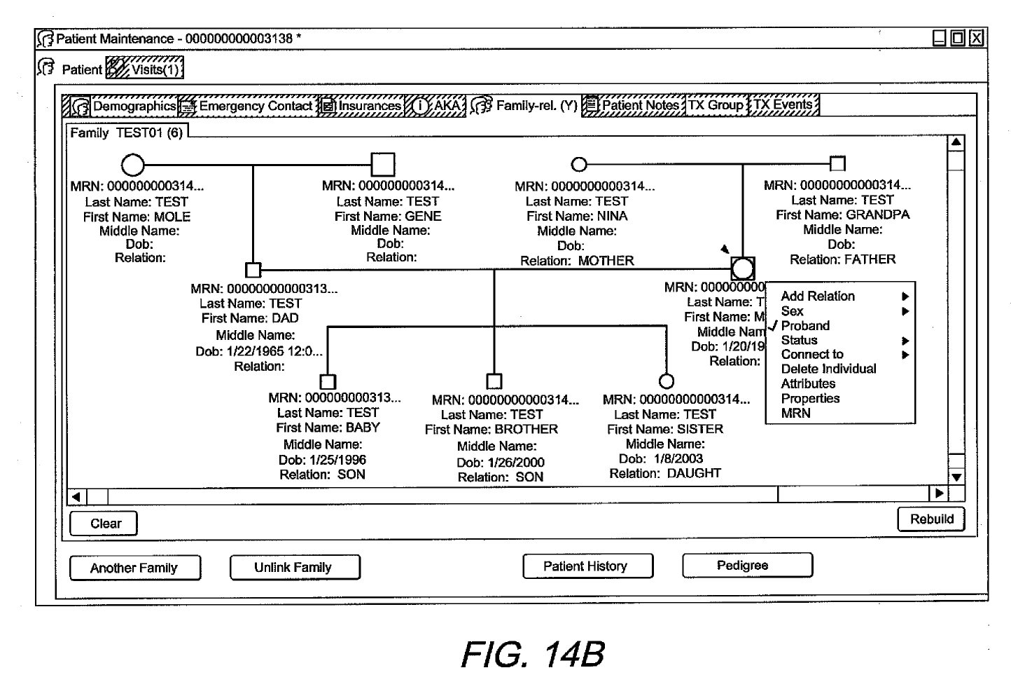

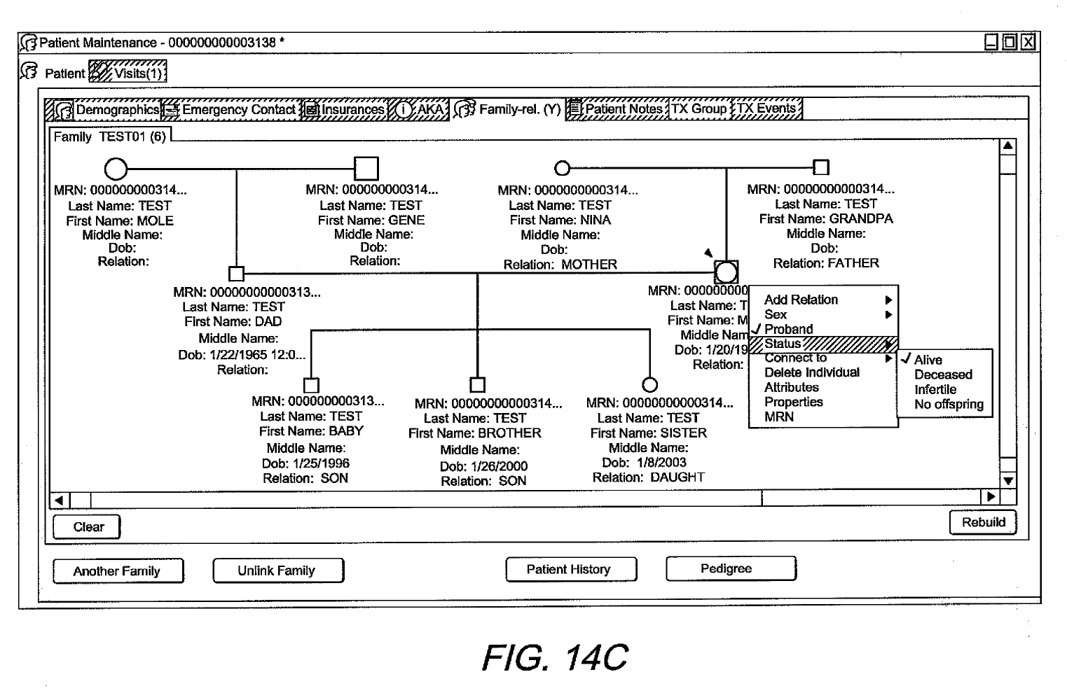

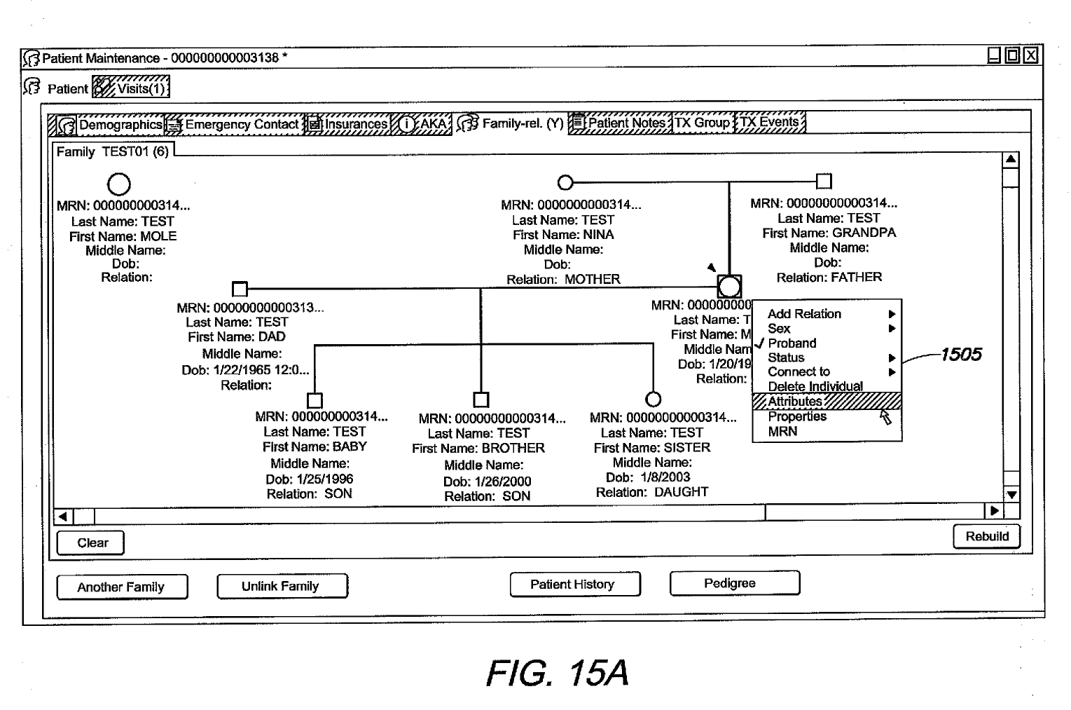

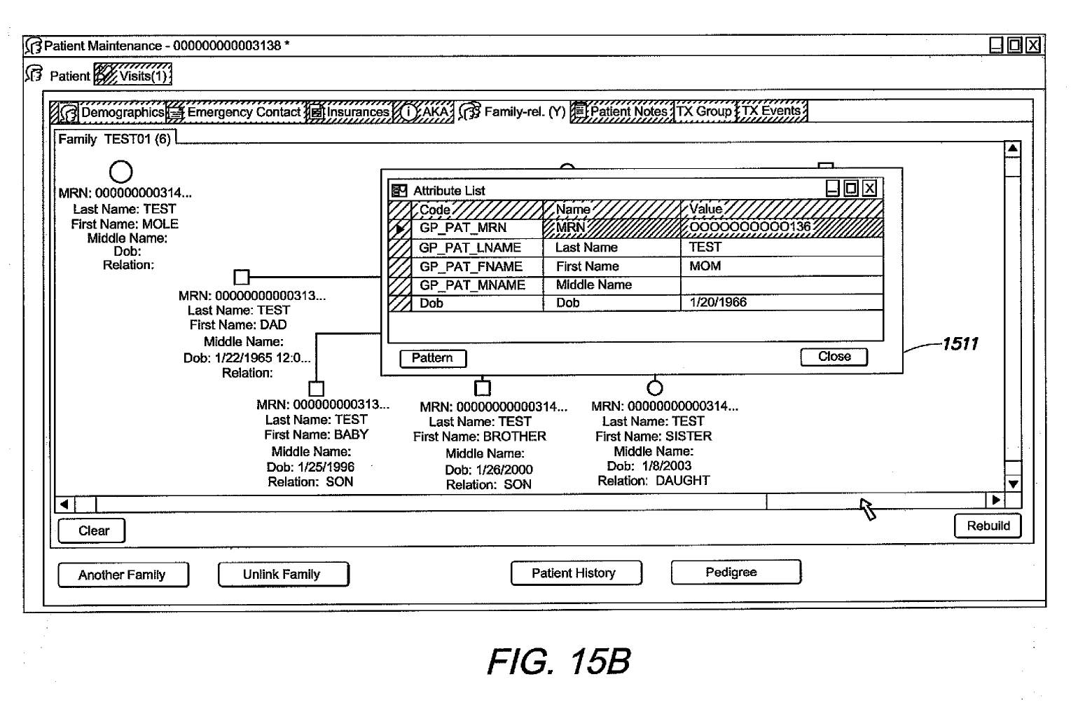

FIGS. 14A-14C illustrate examples of changing and/or setting various properties of the family members in the family tree via the representation of the family tree. FIG. 14A illustrates a user setting the sex of MOLE TEST via the interface provided by the family tree module. FIG. 144B illustrates a user setting the target family member as the proband, and FIG. 14C illustrates the user setting the status of the target family member as alive. It should be appreciated that the interface provided by the family tree module may permit the user to change and/or set any information, property or attribute associated with a family member, as the aspects of the invention are not limited in this respect. For example, FIG. 15A illustrates a user selecting the “Attributes” option in menu 1505 for the target family member which has been selected. FIG. 15B illustrates a window presented by the family tree module as a result of receiving the indication from the user via the “Attributes” option. As illustrated, the Attribute List window 1511 lists the attributes of the selected family member. Any of the displayed attributes may be directly modified or edited via the Attribute List window 1511. The family tree module may then receive the modifications and update and display a representation of the modified family tree and/or update the database with the desired modifications.

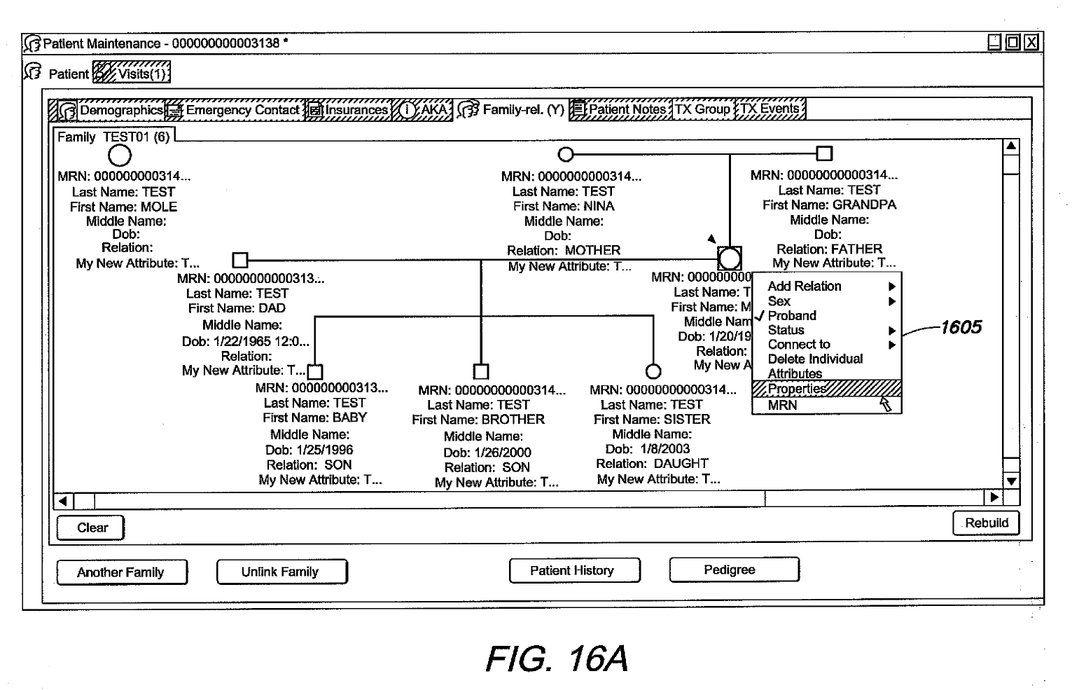

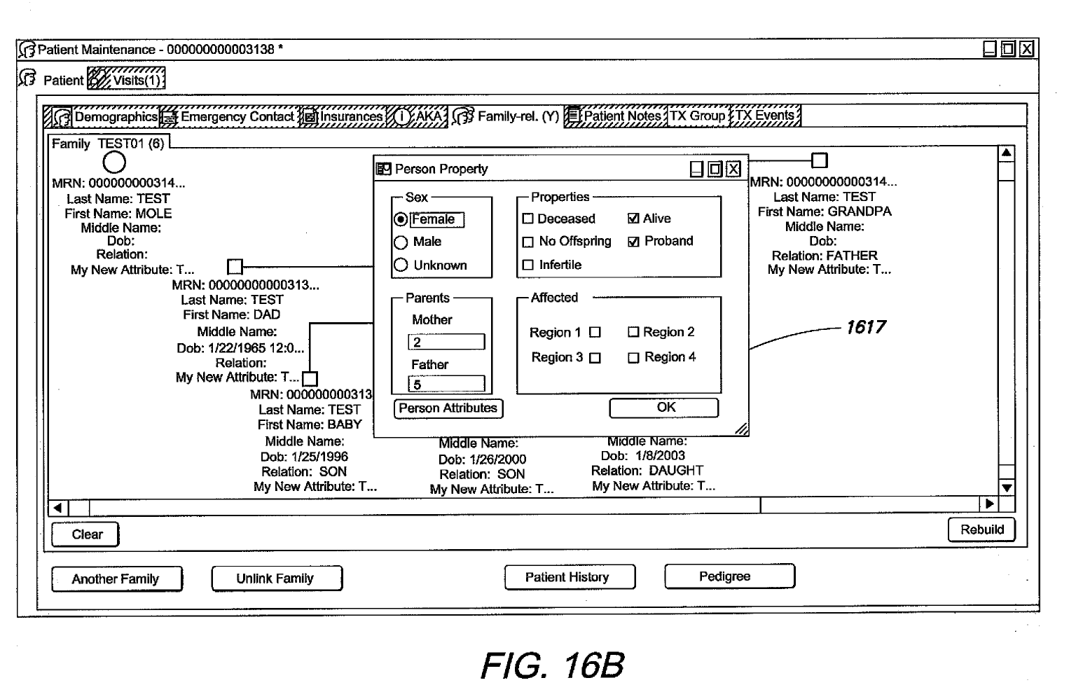

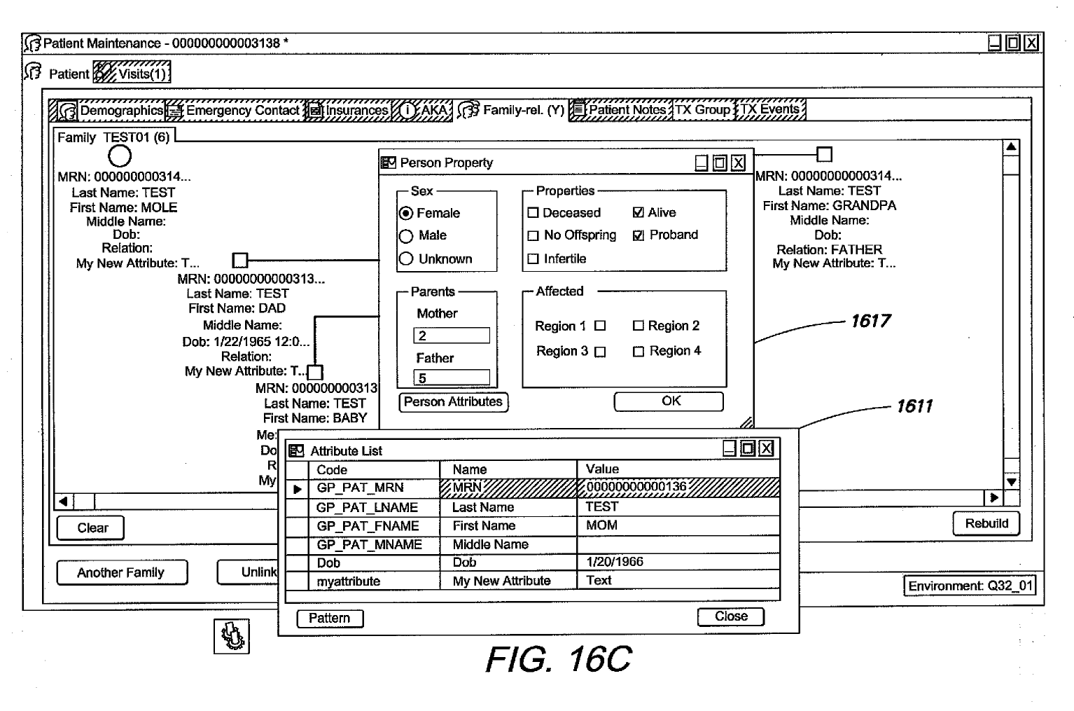

FIG. 16A illustrates a representation of a family tree in which the target family member has been selected and the user has indicated that the user would like to see more options. In response, the family tree module has displayed the options menu 1605 and the user has selected the “Properties” option under the options menu. In response to receiving the indication from the user to view the “Properties” option, the family tree module may present a Person Property window 1617 as illustrated in FIG. 16B. The Person Property window 1617 displays personal properties of the selected family member and includes radio buttons and checkboxes indicating the current value for the corresponding properties. The user may modify or change the value of the properties by clicking the associated radio button or checkbox. Additional properties may also be included in the Personal Property window, as the aspects of the invention are not limited in this respect. FIG. 16C illustrates that the Attribute List window may be accessed via the Personal Property window and edits or modifications to the attributes, including adding a new attribute may be performed in this manner. However, the interfaces that allow a user to perform various edits, updates and/or modifications may be presented in any number of ways, as the aspects of the invention are not limited in this respect.

Display Options

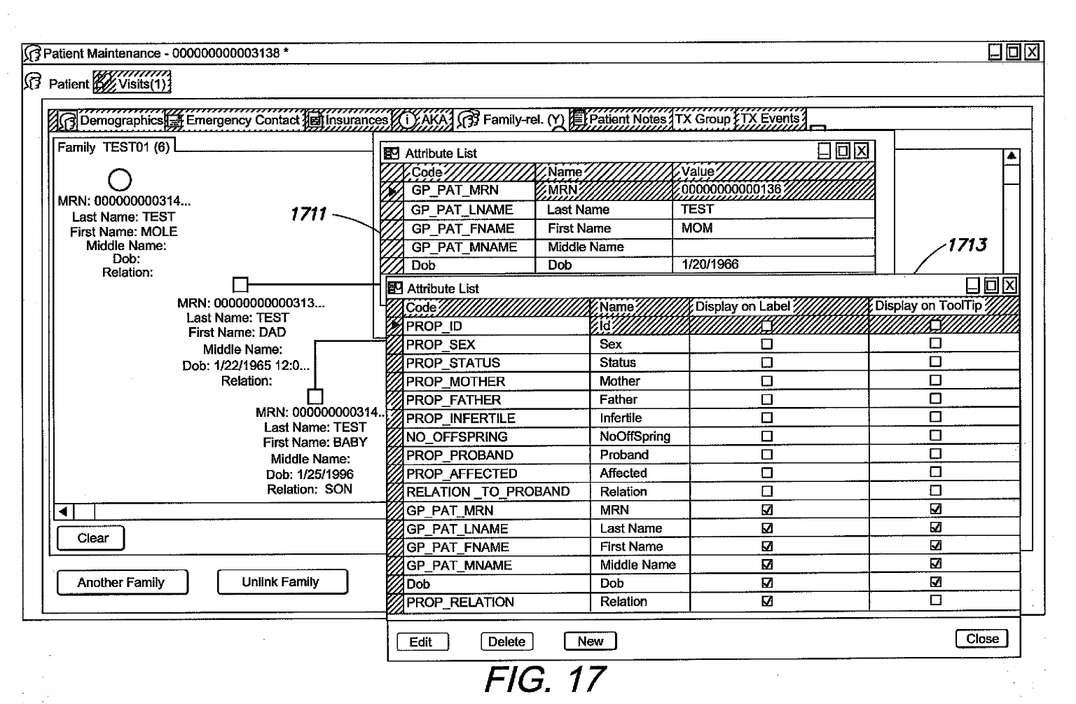

Applicant has appreciated that allowing a user to customize the display of the representation of the family tree may facilitate a more flexible and useable family tree interface. As illustrated in FIG. 15B, the Attribute List window includes a “Patterns” button. FIG. 17 illustrates the result of a user actuating the “Patterns” button. In particular, when the family tree module receives an indication that the user has selected the “Patterns” button, the family tree module may present Extended Attribute List window 1713 to the user. The Extended Attribute List window 1713 may present to the user all of the existing attributes. The attributes may include the default attributes provided by the family tree module and/or user-defined attributes, as discussed in further detail below.

The Extended Attribute List window 1713 includes controls to allow the user to select which attributes should be displayed and in what manner. For example, the checkboxes in the column titled “Display on Label” allows the user to select which attributes appear on the label in association with the graphical icon of each family member in the family tree representation. The checkboxes in the column titled “Display on ToolTip” allows the user to select which attributes should appear when the user hovers an interface device, such as the mouse arrow of a mouse, over the associated graphical icon of a particular family member. These and/or other display options may be made available to the user, as the aspects of the invention are not limited in this respect.

User Defined Attributes

As described above, a family tree module may include a number of default attributes that can be used to identify, label or otherwise characterize members of a family tree and/or that can be displayed in connection with a representation of the family tree. However, Applicant has appreciated that not all users of a family tree module may be interested in the same set of attributes. Some of the default attributes may not be useful to a given user, or more importantly, an attribute that is important to a given user may not be part of the default set of attributes. Accordingly, Applicant has provided interface functionality that allows a user to define any number of attributes to associate with family members of a family tree via interaction with the representation of the family tree.

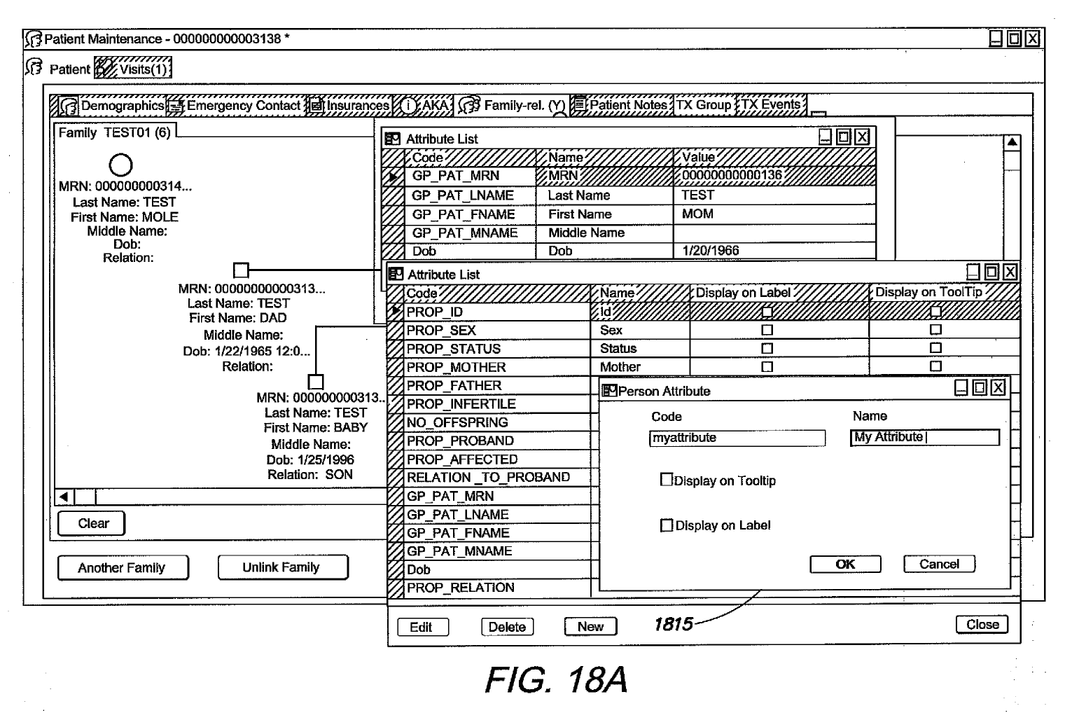

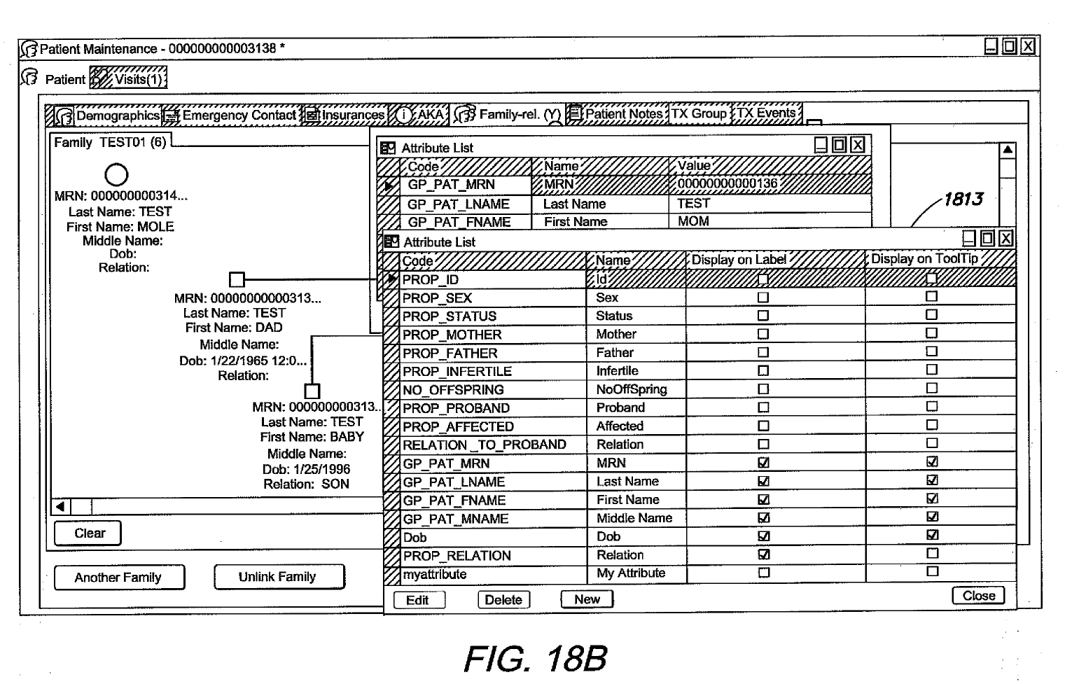

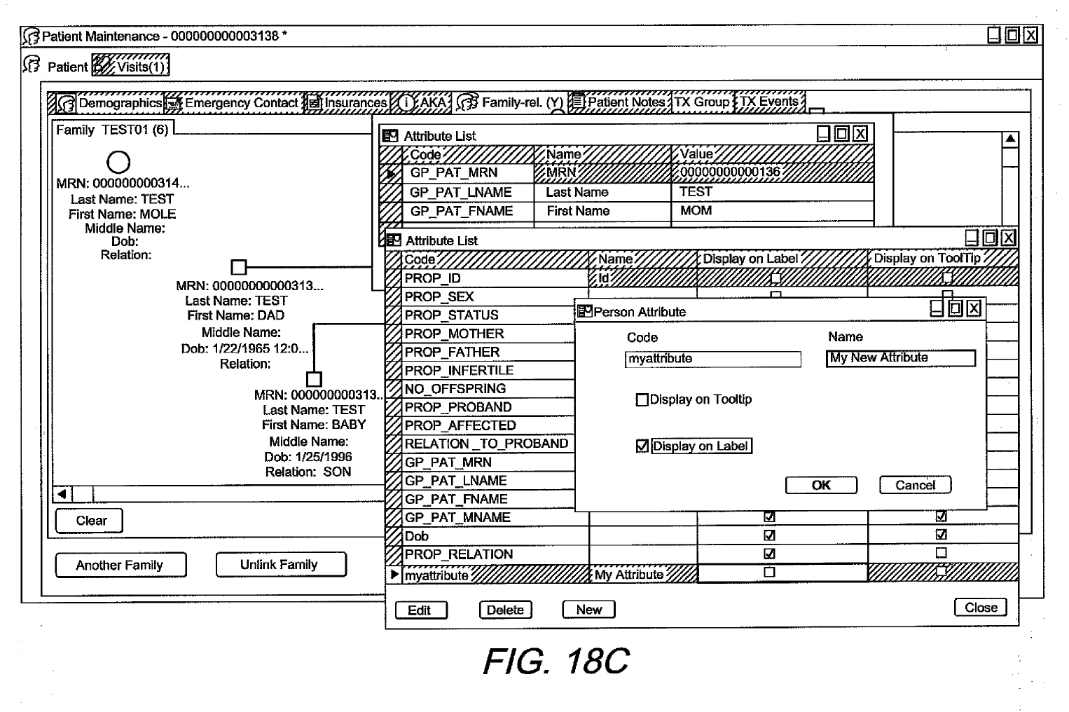

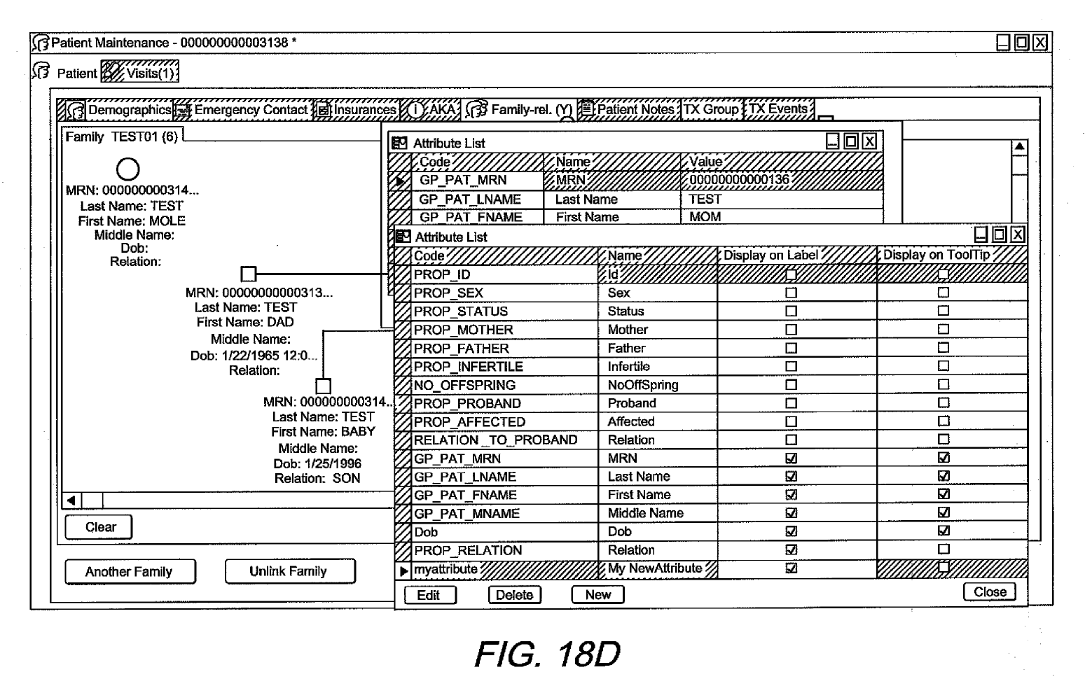

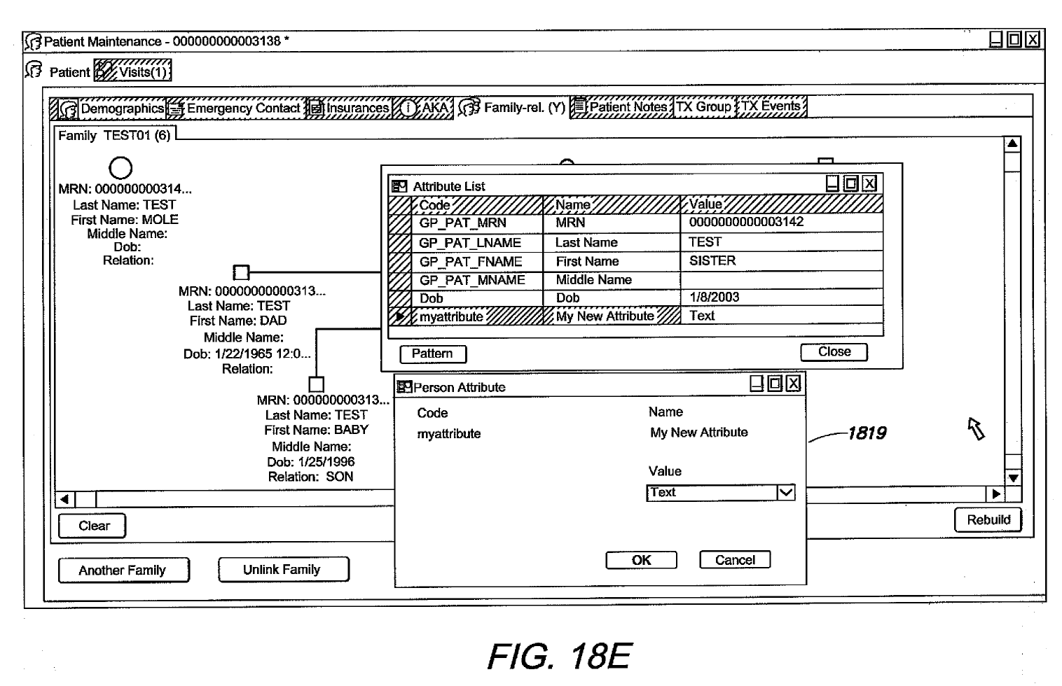

As shown in FIG. 17, the Extended Attribute List window 1713 includes a button labeled “New” that allows the user to add new user-defined and/or customized attributes. FIG. 18A illustrates a Person Attribute window 1815 that allows a user to define a code word and name of an attribute that the user would like to add to the attribute list. In the example illustrated in FIG. 18A, the new attribute is called myAttribute to convey that any attribute of any type may be added to the attribute list. For example, in an exemplary family study, it may be useful to track eye color or hair color. Accordingly, a user may define an eye color and/or a hair color attribute to associate with the family members in the family tree.

The Person Attribute window 1815 also includes checkboxes so that the user can select where and in what manner the user would like the new attribute to be displayed. FIG. 18B illustrates the Extended Attribute List window 1813 after the myAttribute attribute has been added, and as shown, the new attribute appears in the attribute list. FIGS. 18C and 18D illustrate interface functionality to allow the user to define where and in what manner the new attribute is displayed. The display options may also be changed via the Attribute Window, as discussed above in connection with FIG. 15.

After a new attribute has been added, the attribute may be assigned a value. FIG. 18E illustrates a personal attribute window 1819 that allows a user to assign a value to the attribute. This window may be opened by, for example, double clicking on the attribute in the Attribute List window 1813. However, an interface that allows a user to assign a value to a user defined and/or customized attribute may be accessed or presented in any manner, as the aspects of the invention are not limited in this respect. It should be appreciated that the family tree module may be configured to maintain user defined attributes. For example, user-defined or customized attributes may be displayed by the family tree module according to indications made by the user. In addition, user-defined or customized attributes may be added to fields in the patient database to provide additional fields that are searchable by the user. User-defined or customized attributes may be used in other types of queries, analyses and visualization, as the aspects of the invention are not limited in this respect.

The foregoing description includes a number of modifications that may be performed on a family tree and/or a family tree representation via interaction with a graphical representation of the family tree. It should be appreciated that some embodiments may include one, multiple or any combination of the above-described interactions, or other interactions not specifically described herein, as the aspects of the invention are not limited in this respect.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controllers can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code. In this respect, it should be appreciated that one embodiment of the invention is directed to a computer readable storage medium (or multiple computer readable storage media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. The invention is capable of other embodiments and of being practiced or of being carried out in various ways.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method for interacting with a representation of a family tree, the method comprising:
receiving family tree information from a user with respect to the family tree;
displaying a representation of the family tree based, at least in part, on the received family tree information;
receiving update information from the user indicating at least one modification to the family tree and/or the family tree representation, the update information received via the user interacting directly with the graphical representation of the family tree;
performing the at least one modification to the family tree and/or family tree representation; and
displaying a representation of the family tree with the at least one modification.

2. The method of claim 1, wherein receiving the family tree information includes receiving information indicating an existing family tree, and wherein displaying a representation of the family tree includes displaying a representation of the existing family tree.

3. The method of claim 1, wherein receiving the family tree information includes receiving information that facilitates creating a new family tree.

4. The method of claim 1, wherein receiving update information includes receiving update information to add a family member to the family tree, and wherein performing the at least one modification includes adding the family member to the family tree, and wherein displaying includes displaying a representation of the family tree with the added family member.

5. The method of claim 1, wherein receiving update information includes receiving update information to delete a family member from the family tree, and wherein performing the at least one modification includes deleting the family member from the family tree, and wherein displaying includes displaying a representation of the family tree without the deleted family member.

6. The method of claim 1, wherein receiving update information includes receiving update information indicating one of the family members to select, and wherein displaying includes displaying a representation of the family tree with the selected family member highlighted.

7. The method of claim 1, wherein receiving update information includes receiving update information indicating a new attribute to be added to a selected family member, and wherein performing the at least one modification includes adding the new attribute in association with the selected family member.

8. The method of claim 1, wherein the representation of the family tree includes a graphical representation having a graphical icon for each family member in the family tree and a textual representation including a label for each family member, the label having information about the associated family member.

9. The method of claim 8, wherein receiving update information includes receiving update information indicating a change to a value of at least some information in the label for a selected family member, and wherein performing the at least one modification includes changing the value of the at least some information in the label, and wherein displaying the representation of the family tree includes displaying a representation of the family tree with the value of the at least some information changed.

10. The method of claim 8, wherein receiving update information includes receiving update information indicating a change to at least some information displayed in the label for a selected family member, and wherein displaying the representation of the family tree includes displaying a representation of the family tree with the modified label.

11. A computer readable medium encoded with a program for execution on at least one processor, the program, when executed on the at least one processor, performing a method for interacting with a representation of a family tree, the method comprising:
receiving family tree information from a user with respect to the family tree;
displaying a representation of the family tree based, at least in part, on the received family tree information;
receiving update information from the user indicating at least one modification to the family tree and/or the family tree representation, the update information received via the user interacting directly with the graphical representation of the family tree;
performing the at least one modification to the family tree and/or family tree representation; and
displaying a representation of the family tree with the at least one modification.

12. The computer readable medium of claim 11, wherein receiving the family tree information includes receiving information indicating an existing family tree, and wherein displaying a representation of the family tree includes displaying a representation of the existing family tree.

13. The computer readable medium of claim 11, wherein receiving the family tree information includes receiving information that facilitates creating a new family tree.

14. The computer readable medium of claim 11, wherein receiving update information includes receiving update information to add a family member to the family tree, and wherein performing the at least one modification includes adding the family member to the family tree, and wherein displaying includes displaying a representation of the family tree with the added family member.

15. The computer readable medium of claim 11, wherein receiving update information includes receiving update information to delete a family member from the family tree, and wherein performing the at least one modification includes deleting the family member from the family tree, and wherein displaying includes displaying a representation of the family tree without the deleted family member.

16. The computer readable medium of claim 11, wherein receiving update information includes receiving update information indicating one of the family members to select, and wherein displaying includes displaying a representation of the family tree with the selected family member highlighted.

17. The computer readable medium of claim 11, wherein receiving update information includes receiving update information indicating a new attribute to be added to a selected family member, and wherein performing the at least one modification includes adding the new attribute in association with the selected family member.

18. The computer readable medium of claim 11, wherein the representation of the family tree includes a graphical representation having a graphical icon for each family member in the family tree and a textual representation including a label for each family member, the label having information about the associated family member.

19. The computer readable medium of claim 18, wherein receiving update information includes receiving update information indicating a change to a value of at least some information in the label for a selected family member, and wherein performing the at least one modification includes changing the value of the at least some information in the label, and wherein displaying the representation of the family tree includes displaying a representation of the family tree with the value of the at least some information changed.

20. The computer readable medium of claim 18, wherein receiving update information includes receiving update information indicating a change to at least some information displayed in the label for a selected family member, and wherein displaying the representation of the family tree includes displaying a representation of the family tree with the modified label.

21. A system for interacting with a representation of a family tree, the system comprising:
a database for storing at least patient information;
a software module coupled to the database and capable of accessing patient information from the database, the software module configured to provide at least one first interface for display to receive family tree information from a user related to the family tree, display a representation of the family tree based, at least in part, on the received family tree information, provide at least one second interface for display accessible directly on the representation of the family tree to receive update information from the user indicating at least one modification to the family tree, modify the family tree according to the update information, and display a representation of the family tree with the at least one modification.

22. The system of claim 21, wherein the at least one first interface includes an interface for receiving information indicating an existing family tree, and wherein the software module is configured to access the existing family tree from the database and display a representation of the existing family tree.

23. The system of claim 21, wherein the at least one first interface includes an interface for receiving information that facilitates creating a new family tree.

24. The system of claim 21, wherein the at least one second interface includes an interface for receiving update information to add a family member to the family tree, and wherein the software module is configured to add the family member to the family tree and display a representation of the family tree with the added family member.

25. The system of claim 21, wherein the at least one second interface includes an interface for receiving update information to delete a family member from the family tree, and wherein the software module is configured to delete the family member from the family tree and display a representation of the family tree without the deleted family member.

26. The system of claim 21, wherein the at least one second interface includes an interface for receiving update information indicating one of the family members to select, and wherein the software module is configured to display a representation of the family tree with the selected family member highlighted.

27. The system of claim 21, wherein the at least one second interface includes an interface for receiving update information indicating a new attribute to be added to a selected family member, and wherein the software module is configured to add the new attribute in association with the selected family member.

28. The system of claim 21, wherein the representation of the family tree includes a graphical representation having a graphical icon for each family member in the family tree and a textual representation including a label for each family member, the label having information about the associated family member.

29. The system of claim 28, wherein the at least one second interface includes an interface for receiving update information indicating a change to a value of at least some information in the label for a selected family member, and wherein the software module is configured to change the value of the at least some information in the label and display a representation of the family tree with the value of the at least some information changed.

30. The system of claim 28, wherein the at least one second interface includes an interface for receiving update information indicating a change to at least some information displayed in the label for a selected family member, and wherein the software module is configured to display a representation of the family tree with the modified label.
